(19) United States
(12) Patent Application Publication
(10) Pub. No.: US 2025/0083660 A1
(43) Pub. Date: Mar. 13, 2025

(54) POWERTRAIN AND FLEET MANAGEMENT VIA CLOUD COMPUTING

(71) Applicant: Cummins Inc., Columbus, IN (US)

(72) Inventors: Timothy R. Frazier, Columbus, IN (US); J. Steven Kolhouse, Columbus, IN (US); John P. Kresse, III, Martinsville, IN (US)

(73) Assignee: Cummins Inc., Columbus, IN (US)

(21) Appl. No.: 18/728,045

(22) PCT Filed: Jan. 17, 2023
(86) PCT No.: PCT/US2023/010943

§ 371 Date: Jul. 10, 2024

Related U.S. Application Data
(60) Provisional application No. 63/300,378, filed on Jan. 18, 2022.

(51) Int. Cl. B60W 20/16; B60W 10/06; B60W 10/30; B60W 30/182; F01N 5/02; F02D 17/02; F02D 35/00; G07C 5/00

(52) U.S. Cl. CPC B60W 20/16; B60W 10/06; B60W 10/30; B60W 30/182; F01N 5/02; F02D 17/02; F02D 35/0092; G07C 5/008; B60W 2510/06; B60W 2556/45; B60W 2710/0622; B60W 2710/0627

(57) ABSTRACT

A computing system is disposed remote from a vehicle and communicably coupled to the vehicle over a network. The computing system includes a communications interface, one or more processors, and memory storing instructions that when executed by the one or more processors, cause the one or more processors to receive a first emissions data packet from a vehicle controller, the first emissions data packet including a plurality of emissions values regarding operation of a vehicle; determine whether a first cumulative emissions value is greater than a threshold value; and responsive to determining that the first cumulative emissions value is greater than the threshold, performing, by the remote computing system, corrective operations.

### CROSS-REFERENCE TO RELATED PATENT APPLICATION

This application claims the benefit of and priority to U.S. Provisional Application No. 63/300,378, filed Jan. 18, 2022, which is incorporated herein by reference in its entirety and for all purposes.

### TECHNICAL FIELD

The present disclosure relates to systems and methods for managing fleet vehicles and/or individual vehicles or components thereof, such as powertrains, using a remote computing system.

### BACKGROUND

Regulatory bodies such as government agencies may require owners of engine-powered systems such as automotive vehicles to record and/or report certain information, such as engine exhaust emissions data. Regarding emissions, the regulatory bodies may design an emissions test or provide emissions guidelines that are required to be followed by the vehicle owners. The emissions tests may be periodically updated (e.g., every year, every 5 years, etc.). The emissions tests may include testing for cumulative emissions of a fleet of vehicles, average emissions of the fleet, emissions of a particular engine or powertrain, individual vehicle emissions tests, and so on. Emissions data may include data regarding amounts of nitrogen oxides (“NOx”), particulate matter (“PM”), greenhouse gasses (“GHG”), etc. in vehicle emission gasses. In this regard, the published guidelines, requirements, tests, etc. may be generalized and not custom to a particular vehicle and operation of that vehicle. Monitoring emissions data for a vehicle and/or fleet of vehicles is desired.

### SUMMARY

One embodiment relates to a method. The method includes receiving, by a remote computing system, a first emissions data packet from a vehicle controller. The first emissions data packet includes a plurality of emissions values regarding operation of a vehicle. The method also includes determining, by the remote computing system, whether a first cumulative emissions value is greater than a threshold value. The first cumulative emissions value is based on the plurality of emissions values. The method also includes, responsive to determining that the first cumulative emissions value is greater than the threshold, performing, by the remote computing system, corrective operations. The corrective operations include transmitting an indication that the cumulative emissions value is greater than the threshold value to a third-party computing system. The indication includes a request to perform a service operation on the vehicle. The corrective operations also include causing the vehicle to change an operational parameter. The corrective operations also include receiving a second emissions data packet from the vehicle. The corrective operations also include determining, based on the second emissions data packet, whether a second cumulative emissions value is greater than the threshold value. The corrective operations also include responsive to determining that the second cumulative emissions value is less than the threshold value, transmitting, by the remote computing system, a compliance data packet to a third-party computing system. The compliance data packet includes the second emissions data packet and the changed operational parameter.

Another embodiment relates to a method. The method includes generating, by a remote computing system, a first predicted set of emissions values regarding operation of a vehicle. The method also includes receiving, by the remote computing system, a first actual set of emissions values regarding operation of the vehicle from a vehicle computing system. The method also includes determining, by the remote computing system, whether the first predicted set of emissions values is within a predetermined threshold of the first actual set of emissions values. The method also includes, responsive to determining that the first predicted set of emissions values is not within the predetermined threshold of the first actual set of emissions values, transmitting, by the remote computing system, an instruction to change an operational parameter to the vehicle computing system. Changing the operational parameter may include adjusting a fuel injection quantity, a fuel injection timing, or a fuel injection event. Changing the operational parameter may also include adjusting an air handling system. Changing the operational parameter may also include adjusting a fuel blend. Changing the operational parameter may also include causing the engine to utilize a dynamic skip-fire such that an exhaust temperature increases. Changing the operational parameter may also include adjusting an exhaust heater such that the exhaust temperature increases.

Another embodiment relates to a method. The method includes receiving, by a provider computing system, a first emissions data packet from a vehicle computing system. The first emissions data packet includes a plurality of emissions values regarding operation of a vehicle. The method also includes generating, by the provider computing system a plurality of predicted emissions values for the vehicle. The method also includes generating, by the provider computing system, a reporting data packet, the reporting data packet comprising at least one of the first emissions data packet and the plurality of predicted emissions values. The method also includes receiving, by the provider computing system, a first request for a data subscription service. The method also includes transmitting, by the provider computing system, the first emissions data packet responsive to receiving the first request. The method also includes automatically transmitting, by the provider computing system, the first emissions data packet to a regulation computing system.

Another embodiment relates to a method. The method includes receiving, by a vehicle controller, a plurality of emissions values regarding operation of a vehicle from a sensor of the vehicle. The method also includes generating, by the vehicle controller, a first emissions data packet that includes the plurality of emissions values. The method also includes transmitting, by the vehicle controller, the first emissions data packet to a remote computing system. The method also includes receiving, by the vehicle controller, an instruction to change an operational parameter. The operational parameter including one of adjusting a fuel injection quantity, a fuel injection timing, or a fuel injection event, adjusting an air handling system, adjusting a fuel blend, causing the engine to utilize a cylinder deactivation mode, such as a dynamic skip-fire, such that an exhaust temperature increases, and adjusting an exhaust heater such that the exhaust temperature increases. The method also includes generating, by the vehicle controller, a second emissions data packet and transmitting the second emissions data packet to the remote computing system.

Yet another embodiment relates to a method of controlling a mild-hybrid powertrain, such as one included in certain hybrid vehicles. The method includes: receiving, from a first sensor of the mild-hybrid powertrain, a first emissions value; determining that the first emissions value exceeds a predefined threshold value; causing the mild-hybrid powertrain to change a first operational parameter, responsive to determining that the first emissions value exceeds the predefined threshold value; receiving, from the first sensor, a second emissions value; determining that the second emissions value exceeds the predefined threshold value; causing the mild-hybrid powertrain to switch from a first mode of operation to a second mode of operation responsive to determining that the second emissions value exceeds the predefined threshold value; and causing the mild-hybrid powertrain to switch to from the second mode of operation to the first mode of operation responsive to identifying an emergency scenario.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements. Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE FIGURES

FIG. 1 is a block diagram of a system for powertrain and fleet management via cloud computing, according to an example embodiment.

FIG. 2 is a block diagram of a vehicle of the system of FIG. 1, according to an example embodiment.

FIG. 3 is a block diagram of a controller of the vehicle of FIG. 2, according to an example embodiment.

FIG. 4 is a flow diagram of a method of managing operational parameters of the vehicle of FIG. 2, according to an example embodiment.

FIG. 5 is a flow diagram of a method of recalibrating predicated emissions values for the vehicle of FIG. 2, according to an example embodiment.

FIG. 6 is a flow diagram of a method of reporting emissions for the vehicle of FIG. 2, according to an example embodiment.

FIG. 7 is a flow diagram of a method of reporting emissions for the vehicle of FIG. 2, according to an example embodiment.

These and other features, together with the organization and manner of operation thereof, will become apparent from the following detailed description when taken in conjunction with the accompanying drawings.

### DETAILED DESCRIPTION

Following below are more detailed descriptions of various concepts related to, and implementations of methods, apparatuses, and systems for managing powertrain and/or fleet vehicles using a cloud computing system. The various concepts introduced herein may be implemented in any number of ways, as the concepts described are not limited to any particular manner of implementation. Examples of specific implementations and applications are provided primarily for illustrative purposes.

Referring to the Figures generally, the various embodiments disclosed herein relate to systems, apparatuses, and methods for powertrain and fleet management via cloud computing. A controller (e.g., an engine control module (ECM), engine control unit (ECU), other electronic control unit, etc.) for a vehicle includes at least one processor and at least one memory storing instructions that, when executed by the processor, cause the controller to perform various operations. The operations include changing one or more operational parameters of the vehicle. The change may be made responsive to receiving instructions from a remote (e.g., off-vehicle) computing system, such as a cloud computing system. The operations may also include, in response to changing the operational parameter, reporting that change to the cloud computing system and/or a third party computing system.

Other various embodiments disclosed herein relate to systems, apparatuses, and methods for a cumulative information/data recording and/or monitoring service provided to vehicle owners or fleet managers by a vehicle or engine manufacturer. Accordingly, the systems, apparatuses, and methods disclosed herein relate to and/or are capable of performing operations including setting emissions goals, setting targets for emissions, dynamically updating targets based on goals, determining engine performance based on one or more factors such as fuel economy, and reporting results to agencies periodically or in real time (e.g., every second, every minute, etc.). The systems, apparatuses, and methods disclosed herein relate to and/or are further capable of performing operations including detecting, sensing, predicting, or otherwise determining operational data associated with a vehicle. The systems, apparatuses, and methods disclosed herein relate to and/or are further capable of performing operations controlling, adjusting, or otherwise changing the operational parameters of the vehicle.

As used herein the term “operational parameter” and similar terms refer to a value setting (numeric, etc.), an operational state, a control method or sequence, and/or other parameter that defines and controls operation of a piece of equipment or portion thereof (e.g., a vehicle, a vehicle engine, etc.). Examples of operational parameters may include, but are not limited to: an fuel-air mixture ratio, a cruise control (CC) droop amount, a transmission shift schedule, a maximum allowed engine speed, a maximum allowed engine torque, a maximum power delivery, maximum engine speed, torque, load values before implementing a derate condition, and other control parameters regarding operation of a vehicle. The operating parameters may also include control parameters for an exhaust aftertreatment system and other component or system. As an example, control parameters for an exhaust aftertreatment system may include a dosing amount and timing, maximum/minimum allowed exhaust heater values, etc.

As used herein the term “operational data” and similar terms refer to data, information, etc. regarding operation of a piece of equipment, such as a vehicle. The operation or operational data is based on the control parameters for the piece of equipment. The operational data may, in turn, include data regarding operation of an exhaust aftertreatment system (e.g., NOx emissions, GHG emissions, particulate matter emissions, etc.), data regarding operation of an engine (e.g., torque, speed, etc.), data regarding operation of a turbocharger, data regarding operation of a fueling system (e.g., fuel injection timing and quantity), and so on. The operation data may, in some embodiments, include metadata such as a vehicle or engine identifier, a timestamp, a geo-location stamp, and/or other suitable metadata.

As used herein the terms “controlling”, “adjusting”, “changing” and similar terms are used interchangeably to mean changing or modifying an operational parameter by generating and/or transmitting a control signal (e.g., by a controller, such as the controller 300) to one or more systems, sensors, and/or components of a vehicle (e.g., the vehicle 202) such that the system, sensor, and/or component changes one or more particular operational parameters. Such adjustments may be iterative, in which multiple adjustment are made until a desired output is reached. For example, a desired output may include a desired operational parameter, a target and/or threshold value for operational data (e.g., a target emissions output, a target engine torque output, a target speed, a target fuel injection timing and/or quality, etc.). In some embodiments, the adjustment may be made based on a statistical model and/or a machine learning model (e.g., artificial-intelligence). In these embodiments, the adjustments are not necessarily made in a pre-determined manner. Rather, the adjustment of the operating parameters may become unique for the individual piece of equipment (engine, vehicle, operating environment, etc.).

In various embodiments described herein, a controller, such as an engine control unit, utilizes a cylinder deactivation (CDA) mode to control an engine, such as an internal combustion engine. CDA mode is a broad term that encompasses various related but distinct cylinder deactivation operating modes. A first type of CDA operating mode is known as “fixed cylinder CDA.” In fixed cylinder CDA operating mode, the same cylinder(s) are active/inactive each engine cycle during the fixed cylinder CDA operating mode. A second type of CDA operating mode is known as “skip-fire” operating mode. In skip-fire CDA mode, one or more cylinders are deactivated/inactive (e.g., combustion does not occur) on a cycle-by-cycle basis. Accordingly, a cylinder may be inactive for a first engine cycle and active for a second engine cycle. An “active” cylinder means that combustion is allowed to occur in that cylinder. An “inactive” or “deactivated” cylinder means that combustion is not allowed to occur in that cylinder. The present disclosure is applicable with each type of CDA operating mode, and the term CDA mode is meant to encompass all such operating modes unless indicated otherwise. In one embodiment, the controller may utilize a dynamic skip-fire mode.

The systems and methods described herein provide a technical solution to a technical problem of determining vehicle operational data and statuses for an individual and/or fleet of vehicles and/or other equipment (e.g., powertrains, engines, etc.). Additionally, the systems, methods, and apparatuses may enable changing of one or more operational parameters to control an individual vehicle and/or group of vehicles for various purposes. For example, in one embodiment, determining and changing operational parameter(s) may be for a purpose of complying with and/or assessing compliance with various rules and/or laws set forth by local or federal governments and/or regulatory bodies, goals set by fleet stakeholders, and/or other restrictions set by third parties. The systems and method described herein may advantageously reduce vehicle ownership costs of one or more vehicles in a fleet. For example, in any of the above embodiments, the vehicle operational status is concurrently, partially concurrently, or sequentially and/or automatically provided to vehicle stakeholders (e.g., vehicle owners) and/or third parties such as regulatory bodies, government agencies, etc. The vehicle operational statuses advantageously allow the vehicle owner and/or third parties to identify, in real-time, out-of-compliance vehicles based on specific parameters of the particular vehicle (e.g., instead of a manufacturer recommended or periodic testing). The vehicle-specific operational parameters advantageously mitigate against damage, such as engine damage, by recommending operational parameter changes made in real-time to reduce vehicle emissions. Further, the vehicle-specific operational parameters advantageously may reduce vehicle ownership costs by optimizing vehicle performance for a reduce emission output. In an additional example embodiment, the computing systems described herein may advantageously adjust one or more operational parameters of a vehicle automatically (e.g., without user input). For example, a remote computing system may cause a vehicle controller to adjust an air handling system, disable engine cylinders that are performing poorly, and/or adjust other operational parameters described herein below based on emissions data and/or one or more thresholds (e.g., regulatory thresholds, goal thresholds, etc.) in order to improve performance of the individual vehicle and/or fleet.

In a first example operating scenario, the systems and methods described herein include receiving, by a remote computing system, a first operational data packet (which may include a first emissions data packet) from a vehicle controller. The first operational data packet includes a plurality of emissions values related to the operation of a vehicle associated with the vehicle controller. The remote computing system may determine that a first cumulative emissions value is greater than a threshold value. The first cumulative emissions value is based on the plurality of emissions values. The remote computing system may, responsive to determining that the first cumulative emissions value is greater than the threshold, perform a corrective operation. The corrective operation may include transmitting an indication that the cumulative emissions value is greater than the threshold value to a third-party computing system (e.g., regulatory agency computing system, etc.). The indication may include a request to perform a service operation on the vehicle. The corrective operation may also include causing the vehicle to change an operational parameter. The corrective operation may also include receiving a second operational data packet (e.g., which may include a second emissions data packet) from the vehicle. The remote computing system may, responsive to determining that a second cumulative emissions value is less than the threshold value, transmit a compliance data packet to a third-party computing system. The compliance data packet may include the second emissions data packet and the changed operational parameter.

The remote computing system may also receive a plurality of operational data packets. Each of the operational data packets may be associated with a respective vehicle of a plurality of vehicles. The remote computing system may also transmit the plurality of emissions data packets to the third-party computing system. The plurality of vehicles may be grouped by at least one of a fleet, a territory, or a vehicle type. The first emissions data packet further comprises a fuel type and a fuel source.

In another example operating scenario, the remote computing system may generate a first predicted set of emissions values regarding operation of a vehicle. The remote computing system may also receive a first actual set of emissions values regarding operation of the vehicle from a vehicle computing system (e.g., a controller). The remote computing system may, responsive to determining that the first predicted set of emissions values is above the predetermined threshold of the first actual set of emissions values, transmit an instruction to change an operational parameter to the vehicle computing system. Changing the operational parameter includes at least one of: (i) adjusting at least one of a fuel injection quantity, a fuel injection timing, or a fuel injection event; (ii) adjusting an air handling system; (iii) adjusting a fuel-to-air ratio; (iv) implementing a cylinder deactivation mode; and (v) activating a heater disposed in an exhaust aftertreatment system.

The vehicle may have an internal combustion engine, a hybrid electric engine, a battery electric motor and/or any other suitable engine and/or motor type. Accordingly, changing the operational parameter includes adjusting an engine-to-electric battery load based on at least one of the engine status, an engine health, the first predicted set of emissions values, or the first actual set of emissions values. As used herein, the phrase “engine-to-electric battery load” refers to a ratio of power output by a combustion engine compared to a power output by a battery. The power output by the battery may include power provided to an electric motor and/or one or more electric devices of a vehicle. For example, the engine-to-battery load may be the power output by the engine divided by the power output provided by the battery. Thus, increasing the engine-to-electric battery load increases the amount of power provided by the engine relative to the battery and decreasing the engine-to-electric battery load increases the amount of power provided by the battery relative to the engine.

The remote computing system may identify, during implementation of a cylinder deactivation mode, a non-compliant cylinder of a plurality of engine cylinders. The remote computing system may disable the non-compliant cylinder. Identifying, the non-compliant cylinder includes (i) temporarily disabling each cylinder of a plurality of cylinders in a predetermined pattern; (ii) receiving a disabled-cylinder emissions output for each of the cylinders in the predetermined pattern; and (iii) identifying, based on the disabled-cylinder emissions output, at least one non-compliant cylinder.

In yet another example operating scenario, the remote computing system may receive a first emissions data packet from a vehicle computing system. The first emissions data packet may include a plurality of emissions values regarding operation of a vehicle. The remote computing system may generate a plurality of predicted emissions values for the vehicle. The remote computing system may generate a reporting data packet. The reporting data packet may include at least one of the first emissions data packet and the plurality of predicted emissions values. The remote computing system may receive a first request for a data subscription service from a third party computing system. The remote computing system may transmit a reporting data packet that includes the first emissions data packet in response to receiving the first request. The remote computing system may automatically transmit the first emissions data packet to the third party computing system. These and other features, scenarios, examples, and benefits are described more fully herein below.

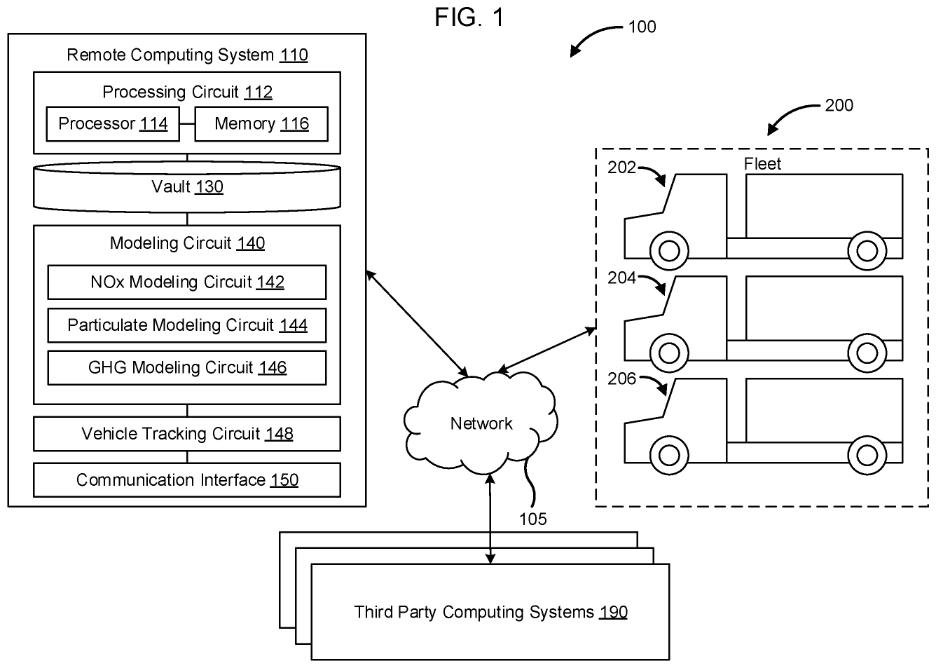

Now referring to FIG. 1, a block diagram of a system 100 for powertrain and fleet management via cloud computing is shown, according to an example embodiment. As shown in FIG. 1, the system 100 includes a network 105, a remote computing system 110, a fleet 200 of vehicles 202, 204, 206, and one or more third party computing systems 190. Each of the components of the system 100 are in communication with each other and are in communication with each other and are coupled by the network 105. Specifically, the remote computing system 110, the third party computing systems 190, and computing systems and/or vehicle controllers of the vehicles 202, 204, 206 of the fleet 200 are communicatively coupled to the network 105 such that the network 105 permits the direct or indirect exchange of data, values, instructions, messages, and the like (represented by the double-headed arrows in FIG. 1).

In some arrangements, the network 105 is configured to communicatively couple to additional computing system(s). In operation, the network 105 facilitates communication of data between the remote computing system 110 and other computing systems associated with the service provider or with a customer of the service provider (e.g., a vehicle or fleet owner) such as a user device (e.g., a mobile device, smartphone, desktop computer, laptop computer, tablet, or any other suitable computing system). The network 105 may include one or more of a cellular network, the Internet, Wi-Fi, Wi-Max, a proprietary provider network, a proprietary service provider network, and/or any other kind of wireless or wired network.

The remote computing system 110 is a remote computing system such as a remote server, a cloud computing system, and the like. Accordingly as used herein, “remote computing system” and “cloud computing system” are interchangeably to mean a computing or data processing system that has terminals distant from the central processing unit (e.g., processing circuit 112) from which users and/or other computing systems communicate with the central processing unit. In some embodiments, the remote computing system 110 is part of a larger computing system such as a multi-purpose server, or other multi-purpose computing system. In other embodiments, the remote computing system 110 is implemented on a third party computing device operated by a third party service provider (e.g., AWS, Azure, GCP, and/or other third party computing services).

The remote computing system 110 is operated by a service provider (e.g., a business). Accordingly, in some embodiments, the remote computing system 110 is a service and/or system/component provider computing system and in turn controlled by, managed by, or otherwise associated with service and/or system/component provider (e.g., an engine manufacturer, a vehicle manufacturer, an exhaust aftertreatment system manufacturer, etc.). In the example shown, the remote computing system 110 is operated and managed by an engine manufacturer (which may also manufacture and commercialize other goods and services). Accordingly, an employee or other operator associated with the service and/or system/component provider may operate the remote computing system 110.

As shown in FIG. 1, the remote computing system 110 includes a processing circuit 112, a vault 130, one or more specialized processing circuits shown as a modeling circuit 140 and a vehicle tracking circuit 148, and a communications interface 150. The processing circuit 112 is coupled to the specialized processing circuits, the vault 130 and/or the communications interface 150. The processing circuit 112 includes a processor 114 and a memory 116. The memory 116 is one or more devices (e.g., RAM, ROM, Flash memory, hard disk storage) for storing data and/or computer code for completing and/or facilitating the various processes described herein. The memory 116 is or includes non-transient volatile memory, non-volatile memory, and non-transitory computer storage media. The memory 116 includes database components, object code components, script components, or any other type of information structure for supporting the various activities and information structures described herein. The memory 116 is communicatively coupled to the processor 114 and includes computer code or instructions for executing one or more processes described herein. The processor 114 is implemented as one or more application specific integrated circuits (ASICs), field programmable gate arrays (FPGAs), a group of processing components, or other suitable electronic processing components. As such, the remote computing system 110 is configured to run a variety of application programs and store associated data in a database and/or the memory 116.

The communications interface 150 is structured to receive communications from and provide communications to other computing devices, users, and the like associated with the remote computing system 110. The communications interface 150 is structured to exchange data, communications, instructions, and the like with an input/output device of the components of the system 100. In some arrangements, the communications interface 150 includes communication circuitry for facilitating the exchange of data, values, messages, etc. between the communications interface 150 and the components of the remote computing system 110. In some arrangements, the communications interface 150 includes machine-readable media storing instructions for facilitating the exchange of information between the communications interface 150 and the components of the remote computing system 110. In some arrangements, the communications interface 150 includes any combination of hardware components, communication circuitry, and machine-readable media.

The communications interface 150 may include a network interface. The network interface is used to establish connections with other computing devices by way of the network 105. The network interface includes program logic that facilitates connection of the remote computing system 110 to the network 105. In some arrangements, the network interface includes any combination of a wireless network transceiver (e.g., a cellular modem, a Bluetooth transceiver, a Wi-Fi transceiver) and/or a wired network transceiver (e.g., an Ethernet transceiver). For example, the communications interface 150 includes an Ethernet device such as an Ethernet card and machine-readable media such as an Ethernet driver configured to facilitate connections with the network 105. In some arrangements, the network interface includes the hardware and machine-readable media sufficient to support communication over multiple channels of data communication. Further, in some arrangements, the network interface includes cryptography capabilities to establish a secure or relatively secure communication session in which data communicated over the session is encrypted.

In an example embodiment, the communications interface 150 is structured to receive information from the vehicles 202, 204, 206 and provide the information to the components of the remote computing system 110. The communications interface 150 is also structured to transmit instructions from the components of the remote computing system 110 to the vehicles 202, 204, 206.

The memory 116 may store a vault 130, according to some arrangements. The vault 130 retrievably stores data associated with the remote computing system 110 and/or any other component of the system 100. That is, the data includes information associated with each of the components of the system 100. For example, the data includes information about one or more vehicles 202, 204, 206 of the fleet 200. The information about the fleet 200 includes information received from one or more vehicles 202, 204, 206, predicted or estimated regarding one or more of the vehicles, and/or information about the one or more vehicles 202, 204, 206 (e.g., vehicle identification number, etc.). For example, the information includes a vehicle or equipment powertrain type (e.g., an internal combustion engine powered vehicle, a hybrid engine, a mild-hybrid powertrain, a parallel hybrid powertrain, a series hybrid powertrain, a series-parallel powertrain, a battery electric vehicle a range extender electric vehicle, a fuel-cell vehicle, etc.), a chassis type, a drag coefficient, tire sizes, tire pressures, a vehicle connectivity indicator (e.g., an ability of the vehicle to communicatively couple and/or coordinate operations to/with other vehicles), etc. A mild-hybrid engine refers to a vehicle or powertrain that includes an internal combustion engine and an electric motor/generator, in a parallel configuration, that allows the internal combustion engine to be turned off in certain operating conditions (e.g., coasting, braking, stopped, etc.). The information may also include vehicle location information (e.g., GPS data over time, at a particular time, etc.). For at least partially electric vehicles, the information may also include vehicle information such as electric drive motor data (e.g., a type, a responsiveness, and a maximum torque output), electric drive motor input characteristics (e.g., voltage, current, etc.), electric drive motor output torque reported in real-time or near real-time, drive motor health (e.g., based on one or more diagnostic indicators), and/or a battery charging source (e.g., alternator, external power, regenerative braking, etc.). The information may also include battery information, such as a battery type, a battery quantity, a battery capacitance, a total capacitance of a battery system, a battery age, a state-of-charge (SOC) of one or more individual batteries, a SOC of the battery system overall (a collective of the SOCs of all the batteries in the system), and/or a battery health of individual batteries. The information may also include engine information (for equipment with internal combustion engines), such as an engine type (e.g., a spark ignition (SI), a compression ignition (CI) engine, a fuel cell engine (e.g., a hydrogen fuel cell engine), etc.), an engine displacement, a fuel type, a fuel level (e.g., in gallons or other metric), and/or an engine health (e.g., based on one or more diagnostic indicators). In some embodiments, the vehicle includes a fuel cell (e.g., hydrogen fuel cell) engine, the information may include information regarding a stack type, a stack design, a fuel level (e.g., an available quantity, a vehicle range based on the fuel level), and/or a fuel cell health (e.g., based on one or more diagnostic indicators). The information may also include dynamic vehicle information, such as vehicle route information, such as a destination, expected traffic, expected and/or determined weather conditions, and/or route grade (e.g., changes in elevation) at various locations. The dynamic information may also include vehicle trip information, such as a departure date and time, a departure location, expected stops (e.g., by GPS coordinates), estimated trip duration (e.g., in distance and time, etc.), etc. The information may also include charging system information (e.g., for batteries in, for example, hybrid vehicles) such as a generator information (e.g., type, quantity, output voltage, output current, generator health, etc.) and/or a system charging time. The information may also include operator information, such as an operator age, an operator health, and a determined/tracked operator driving behavior (e.g., typical cruise set speed, acceleration tendencies, deceleration tendencies, length of continuous driving periods, frequency of stops, etc.). The information may also include fuel characteristics, such as an indication of whether the fuel is from a renewable source or a non-renewable source and/or an actual or an estimated GHG emissions associated with fuel formulation (commonly known as “well to tank” or “WTT”). In some embodiments, the fuel characteristics include an emissions value of using the fuel in the vehicle for powering the vehicle in combination with the well to tank emissions values (the collective value may be known as “well to wheel” or “WTW”). The data also includes information associated with the third party computing systems 190 such as a history of emissions data requests, emissions tests for fleets, vehicles, engines, and/or engine cylinders, vehicle purchase history, vehicle sales history, and/or any other information associated with the third party computing systems 190.

The fleet data and/or the third part computing systems data is retrievable, viewable, and/or editable by the remote computing system 110 (e.g., by a user input). The information also includes an identifier for a vehicle (e.g., the vehicle 202). The vehicle identifier is a unique code or string of alpha, numeric, and/or alpha-numeric values that is associated with a specific vehicle, such as a vehicle identification number (VIN), a serial number, an engine serial number, a fleet identifier, a controller IP address, and so on. Accordingly, any of the information described above may include metadata that includes the identifier such that the information can be associated with a particular vehicle.

The vault 130 may be configured to store one or more applications and/or executables to facilitate tracking data (e.g., vehicle data, operation parameters, operation data, fleet data, and/or emissions data), managing incoming emissions data requests or emissions tests, managing on-vehicle control systems, or any other operation described herein. In some arrangements, the applications and/or executables are incorporated with an existing application in use by the remote computing system 110. In some arrangements, the applications and/or executables are separate software applications implemented on the remote computing system 110. The applications and/or executables may be downloaded by the remote computing system 110 prior to its usage, hard coded into the memory 116 of the processing circuit 112, or be a network-based or web-based interface application such that the remote computing system 110 provides a web browser to access the application, which may be executed remotely from the remote computing system 110 (e.g., by a user device). Accordingly, the remote computing system 110 includes software and/or hardware capable of implementing a network-based or web-based application. For example, in some instances, the applications and/or executables include software such as HTML, XML, WML, SGML, PHP (Hypertext Preprocessor), CGI, and like languages.

In some arrangements, the remote computing system 110 includes hardware, software, or any combination of hardware and software structured to facilitate operations of the components of the system 100. For example, and as shown in FIG. 1, the remote computing system 110 includes a modeling circuit 140 that includes any combination of hardware and software for making computer-generated predictions or estimates based on one or more statistical models.

The modeling circuit 140 is structured to predict, estimate, and/or determine via one or more algorithms, statistical models, etc. to determine vehicle operational data based on vehicle data (e.g., vehicle data/vehicle information including vehicle operational parameters) that is stored by the vault 130. For example, the modeling circuit is structured to determine (e.g., via a reception of the data over a network) a vehicle weight (e.g., gross vehicle weight), a vehicle/equipment location (e.g., GPS data), a vehicle speed, and/or a vehicle acceleration. The modeling circuit is further structured to compare predicted operational data with actual operational data that is reported by a vehicle 202, 204, 206 and adjust the calculation of the predicted values based on the actual operational data. For example, the modeling circuit 140 may be structured to update one or more statistical models (e.g., machine learning models, regression models, and the like) based on comparing the predicted operational data with the actual operational data and determining that a difference between the predicted operational data and the actual operational data exceeds a predetermined threshold. The predicted operational data may include, but is not limited, a predicted engine out NOx value, a predicted system out NOx value (e.g., at the tailpipe), a predicted particulate matter output value at various locations, a predicted GHG outlet amount value, and so on. The actual operational data may include sensed NOx values at various locations (e.g., engine out, tailpipe, etc.), sensed particulate matter output amount values (e.g., engine out, tailpipe, etc.), sensed GHG outlet amount values (e.g., at the tailpipe), and so on. A comparison may be made between corresponding values (predicted versus actual) to, for example, recalibrate sensors, improve models, and so on as described herein.

In some arrangements, the modeling circuit 140 includes one or more specialized circuits having any combination of hardware and software. For example, and as shown in FIG. 1, the modeling circuit 140 includes a NOx modeling circuit 142, a particulate modeling circuit 144, and a GHG modeling circuit 146. Accordingly, the modeling circuit 140, including one or more of the components of the modeling circuit 140 (e.g., the NOx modeling circuit 142, the particulate modeling circuit 144, and the GHG modeling circuit 146), is structured to generate a computer-generated prediction of NOx, particulate matter, and/or GHG (or another exhaust gas constituent) exhaust emissions of a fleet (e.g., fleet 200), a vehicle (e.g., vehicle 202, 204, 206), and/or engine (e.g., an engine of the vehicle 202). Specifically, the NOx modeling circuit 142 is structured to generate a computer-generated prediction of NOx concentration (e.g., a percentage, parts per unit, etc.) in exhaust emissions. The particulate modeling circuit 144 is structured to generate a computer-generated prediction of particulate matter concentration (e.g., a percentage, parts per unit, etc.) in exhaust emissions. The GHG modeling circuit 146 is structured to generate a computer-generated prediction of GHG concentration (e.g., a percentage, parts per unit, etc.) in exhaust emissions. In some embodiments, the GHG modeling circuit 146 is structured to generate a computer-generated prediction of GHG concentration for one or more types of GHG (e.g., carbon dioxide, methane, etc.) as a total amount, individually, or both.

The modeling circuit 140 and/or any circuit thereof (e.g., the NOx modeling circuit 142, the particulate modeling circuit 144, and the GHG modeling circuit 146) may include any combination of hardware and software for generating the computer-generated predictions briefly described above. In an example embodiment, the modeling circuit 140 include one or more statistical models, such as a regression model, extrapolation, a machine learning model, etc., for generating the computer-generated predictions. The one or more statistical models may receive historical data including vehicle information that includes one or more operational parameters and/or operational data. The vehicle information may include information such as a vehicle type, a vehicle location, duty cycle information and/or other information described herein (e.g., operational parameters and/or operational data). The modeling circuit 140 is structured to train the statistical models by inputting the historical data. The modeling circuit 140 may thereafter input new data into the trained statistical models, and the trained statistical models output a predicted operational data based on the historical data and the new data.

In some embodiments, the modeling circuit 140 may utilize a regression analysis, machine learning techniques, and/or other statistical techniques to correlate historical data with new data. In some embodiments, the modeling circuit 140 may utilize a comparison between new data and historical data for similar vehicles, similar duty cycles, similar operating conditions, and so on to predict future output for a vehicle under similar conditions (e.g., same route, time of day, altitude, etc.). In some embodiments, the modeling circuit 140 may use any combination of the techniques described herein for generating computer-generated predictions.

In some embodiments, the remote computing system 110 includes any combination of hardware and software including specialized processing circuits, applications, executables, and the like for controlling, managing, or facilitating the operation of the other computing systems of the system 100 including the third party computing systems 190 and computing systems of the vehicles 202, 204, 206 of the fleet 200. For example, the remote computing system 110 includes a vehicle tracking circuit 148 and associated software for tracking the vehicles 202, 204, 206 of the fleet 200. For example, the vehicle tracking circuit 148 is structured to receive (e.g., via the communications interface 150) information about the vehicles 202, 204, 206 of the fleet 200 such as a vehicle owner, a vehicle type, a vehicle history including past and present owners, locations, maintenance reports, fuel efficiency, exhaust emissions (e.g., NOx, particulate matter, and/or GHG concentrations), and/or any other information associated with the vehicle.

In some embodiments, the third party computing systems 190 include one or more computing systems associated with one or more third parties (e.g., parties that are not the service provider). For example and in one embodiment, the third party computing systems 190 may include a computing system associated with a fleet owner, a vehicle operator, an original equipment manufacturer (OEM), a distributor, a repair facility, a direct customer, a third party customer (e.g., a customer of the direct customer), a regulatory body, a governing body, and/or any other party of interest (e.g., vehicle stakeholder such as a fleet manager, equipment manager, etc.). In some embodiments, a third party computing system registers (e.g., via an operator/user of the third party computing system) with the remote computing system 110. In these embodiments, the remote computing system 110 may provide a portal (e.g., a webpage and/or a graphical user interface) for registering with and/or accessing the remote computing system 110. The remote computing system may be structured to generate and/or receive (e.g., via a user input) a credential and/or a password (e.g., login information) for registering one or more of the third party computing systems 190 and/or accessing, by one or more of the third party computing systems 190, the remote computing system 110. The registered third party computing systems 190 may access data stored by the remote computing system 110. For example, the registered third party computing systems 190 may use the portal to access one or more reports. The one or more reports may include vehicle information (e.g., operational parameters and/or operational data) and any/other tracked information, analyses of the tracked information (e.g., emissions compliance with one or more regulations), etc. In some embodiments and described in detailed herein below, the one or more reports are provided to the third party computing systems 190 responsive to one or more of the third party computing systems 190 sending a request to the remote computing system, automatically based on a repeating request, and/or automatically without a request. In some embodiments, the reports are provided to the third party computing system 190 in real-time. In other embodiments the reports are published on the portal such that the third party computing system 190 may access the reports by providing login information to the portal.

In some embodiments, the one or more reports are made available through subscription-based service that is provided by the remote computing system 110. The subscription-based service may be a fee-based service that allows users of the third party computing systems 190 to view the reports upon payment of a fee (e.g., periodic, one-time, a combination thereof, etc.). The reports may be used to monitor, manage, report, and optimize operations (cost, emissions, routes, etc.). In some embodiments, the subscription-based service includes automatically providing the reports to additional third parties. For example, a first third party (e.g., a customer) purchases the subscription-based service and the remote computing system 110 can provide the reports to a second third party (e.g., a government agency, a regulatory body, etc.) on behalf of the first third party. Accordingly and as described herein, the report may include vehicle information (e.g., operational data and/or operational parameters) including, for example, engine performance data, emissions data, and/or indications of compliance, non-compliance and/or corrective actions based on non-compliance, and/or other information regarding tacked vehicle and/or fleet data.

The third party computing systems 190 include processing circuitry that may be similar to the processing circuit 112 and a communications interface similar to the communications interface 150 such that the third party computing systems 190 are operable to communicate with the remote computing system 110 and/or the fleet 200 via the network 105.

As shown in FIG. 1, the fleet 200 includes a first vehicle 202, a second vehicle 204, and a third vehicle 206. In some embodiments, the fleet 200 includes more or fewer (e.g., at least one) vehicles. While shown as vehicles, in other embodiments, the fleet includes other equipment (e.g., gensets, etc.) in addition to or in place of the vehicle fleet. In yet other embodiments, the fleet includes off-road equipment (e.g., power generators, mining equipment, construction equipment, marine equipment, excavation equipment, etc.). The fleet 200 is associated with at least one of the service provider, a direct customer of the service provider, a third party customer, a location (e.g., a city, a state, a region, a country, etc.), a vehicle type (e.g., engine type, chassis type, workload type, etc.), and/or any other categorizing parameter associated with the vehicle. For example, the fleet 200 may be associated with a first customer, a first vehicle type, and a first region and may include one or more vehicles 202, 204 206. In the example shown, the fleet 200 is associated with a third-party that operates, controls, uses, and/or is associated with a third party computing system 190.

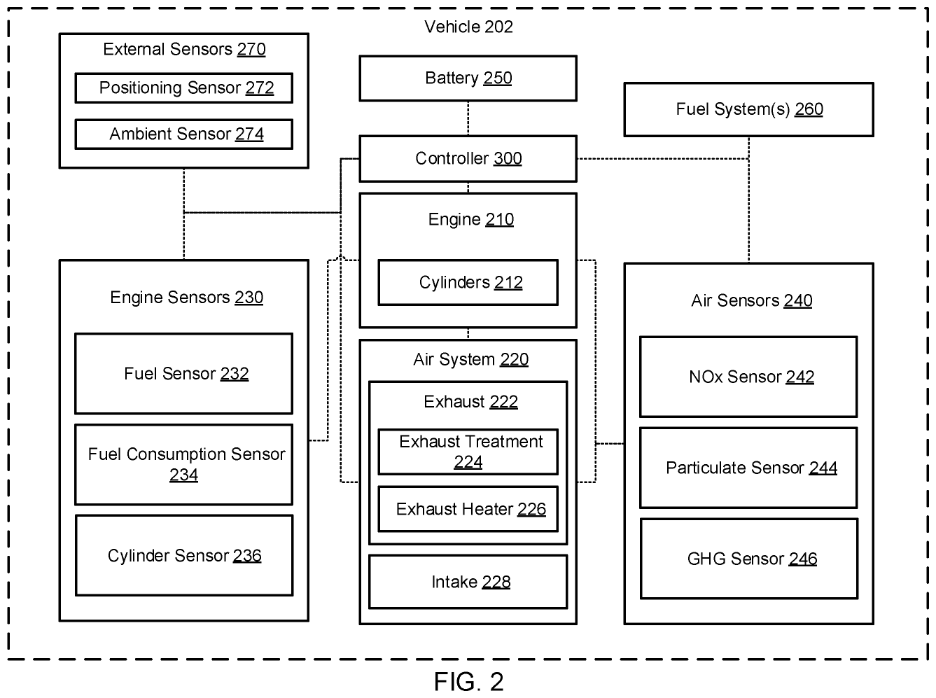

FIG. 2 is a block diagram of a vehicle 202 of the system 100 of FIG. 1, according to an example embodiment. It should be appreciated that the description of the vehicle 202 may be applicable to any of the vehicles of the fleet 200. Accordingly and as alluded to above, the vehicle may be any type of passenger or commercial automobile, such as a commercial on-road vehicle including but not limited to, a line haul truck (e.g., a semi-truck, a school bus, a garbage truck, etc.); a non-commercial on-road vehicle, such as a car, truck, sport utility vehicle, cross-over vehicle, van, minivan, automobile; an off-road vehicle, such as tractor, airplane, boat, forklift, front end loader, etc.; a stationary vehicle (e.g., a generator, an air compressor); and/or any other type of machine or vehicle that is suitable for the systems described herein.

The vehicle 202 is shown to include an engine 210, an air system 220, engine sensors 230, air sensors 240, a battery 250, fuel systems 260, external sensors 270, and a controller 300. In some embodiments, the vehicle 202 may include more, fewer, or different components than in the embodiment shown in FIG. 2. For example, an electric vehicle may include more, fewer, or different engine sensors than an internal combustion engine vehicle. The vehicle 202 includes a sensor array that includes a plurality of sensors. The sensors are coupled to the controller 300, such that the controller 300 can monitor, receive, and/or acquire data indicative of operation of the vehicle 202 (which may be referred to as operational data associated with the vehicle herein). In this regard, the sensor array may include one or more physical (real) or virtual sensors. As used herein, a “physical sensor” or a “real sensor” is a sensor that detects operational data directly. As used herein, a “virtual sensor” is a sensor that determines operational data based on other acquired data. For example, a virtual sensor may determine a vehicle speed based on a detected engine speed using one or more processes, algorithms, etc. The sensor array may include any of the engine sensors 230, air sensors 240, external sensors 270, and/or other sensors associated with the vehicle 202. For example, the sensor array may include temperature sensors. The temperature sensors acquire data indicative of or, if virtual, determine an approximate temperature of various components or systems, such as the exhaust gas at or approximately at their disposed location. A speed sensor is configured to provide a speed signal to the controller 300 indicative of a vehicle speed. In some embodiments, there may be a sensor that provides a speed of the vehicle (e.g., miles-per-hour) while in other embodiments the speed of the vehicle may be determined by other sensed or determined operating parameters of the vehicle (e.g., engine speed in revolutions-per-minute may be correlated to vehicle speed using one or more formulas, a look-up table(s), etc.). The sensor array may also include a fuel tank level sensor that determines a level of fuel in the vehicle 202, such that a fuel economy may be determined based on the speed of the vehicle relative to the fuel consumed by the engine 210 (i.e., to determine a distance-per-unit of fuel consumed, such as miles-per-gallon or kilometers-per-liter, etc.). Additional sensors may be used alone or in combination to determine various operational data regarding the vehicle 202 including, but not limited to, an oxygen sensor, an engine speed sensor, a mass air flow (MAF) sensor, and a manifold absolute pressure sensor (MAP). Based on the foregoing, the controller 300 may determine a fuel economy (or other information) for the vehicle 202 which may be provided to the operator and, in some embodiments, transmitted to the remote computing system 110 for use by, for example, the modeling circuit 140.

The sensors may include a flow rate sensor that is structured to acquire data or information indicative of flow rate of a gas or liquid through the vehicle (e.g., exhaust gas through an aftertreatment system or fuel flow rate through an engine, exhaust gas recirculation flow at a particular location, a charge flow rate at a particular location, an oil flow rate at various positions, a hydraulic flow rate at a particular location, etc.). The flow rate sensor(s) may be coupled to an aftertreatment system of the vehicle 202 and/or elsewhere in the vehicle 202.

The sensor array may further include any other sensors in addition to the sensors described herein. Such sensors may be used to determine a duty cycle for the vehicle 202, and particularly, the engine 355. A duty cycle refers to a repeatable set of data, values, or information indicative of how the specific vehicle is being utilized for a particular application. In particular, a “duty cycle” refers to a repeatable set of vehicle operations for a particular event or for a predefined time period. For example, a “duty cycle” may refer values indicative of a vehicle speed for a given time period. In another example, a “duty cycle” may refer to values indicative of an aerodynamic load on the vehicle for a given time period. In yet another example, a “duty cycle” may refer to values indicative of a vehicle speed and an elevation of a vehicle for a given time period. In this regard and compared to a vehicle drive cycle, which is typically limited to time versus speed information, the term “duty cycle” as used herein is meant to be broadly interpreted and inclusive of vehicle drive cycles among other quantifiable metrics. Beneficially and based on the foregoing, the “duty cycle” may be representative of how a vehicle may operate in a particular setting, circumstance, or environment (e.g., a seventy-file mile stretch of a relatively flat freeway environment). In this regard, the vehicle duty cycle may vary greatly based on the vehicle (e.g., a two-door sedan vehicle versus a concrete mixer truck versus a refuse truck versus a semi-tractor trailer vehicle).

As shown in FIG. 2, the components of the vehicle 202 are connected by data lines shown by the dotted lines. The data lines are structured to facilitate sending and receiving data signals to/from the components of the vehicle 202. In some embodiments, the data signals are structured to pass through one or more components such as the controller 300. For example, the engine sensors 230 are operable to communicate with the fuel systems 260 such that the engine sensors 230 may detect operational data associated with the fuel system 260. Accordingly any of the components of the vehicle 202 may be communicatively coupled to any other component via a direct data signal or indirectly via the controller 300.

In some embodiments, the engine 210 is an internal combustion engine (ICE) such as a spark ignition (S.I.) engine or a compression ignition (C.I.) engine. Accordingly, the engine 210 includes one or more cylinders 212. One or more of the cylinders 212 may be individually controllable by an engine control module (ECM) such as the controller 300. The engine 210 is structured to provide mechanical energy to power the vehicle 202. For example, the engine 210 is structured to consume a fuel (e.g., gasoline, diesel, etc.) to generate power.

In other embodiments, the vehicle includes an electric engine such as an electric motor, a fuel cell engine, and/or any other suitable engine type. As such, the vehicle may be a hybrid vehicle (e.g., a parallel or series hybrid, a full electric vehicle, a plug-in hybrid vehicle, etc.), a fuel cell powered vehicle, and so on. The vehicle may also include a battery 250 for powering the electric motive device/engine. In some embodiments, the vehicle 202 is a range-extended electric vehicle having a range extender (e.g., a fuel-based auxiliary power unit, or other suitable range extender). When the vehicle includes an electric motor, the electric motor(s) may generate electric power from one or more electrical energy storage devices (e.g., one or more batteries 250 that may be charged with electric power, a hydrogen source for fuel cell applications, etc.).

The air system 220 includes an exhaust 222 and an intake 228. The air system 220 is a system for directing and circulating air through the vehicle 202 (e.g., for cooling, exhaust, etc.). The intake 228 is structured to provide air to the engine 210. The exhaust 222 is structured to exhaust gas from the engine 210.

The exhaust 222 may include an exhaust aftertreatment system 224, which may include one or more filters (e.g., a diesel particulate filter or other filtration device), one or more catalysts (e.g., a selective catalytic reduction system, a three-way catalyst, etc.), one or more reductant dosing systems and devices, one or more heaters 226, and/or any other aftertreatment system component/device. The exhaust aftertreatment system 224 is structured to reduce/change the amount/type of air contaminants (e.g., NOx, particulate matter, GHG, etc.), for example, by oxidizing carbon monoxide into carbon dioxide, reducing NOx into nitrogen gas, etc. The air system 220 may further include one or more of a variable-geometry turbocharger (VGT), an exhaust gas recirculation (EGR), an intake valve, an exhaust valve, a charge air cooler (CAC), an exhaust gas recirculation (EGR) cooler, one or more throttles, etc.

The heater 226 is structured to increase (e.g., by turning on or increasing power) or decrease (e.g., by turning off or decreasing power) the temperature of exhaust gasses. For example, the heater 226 is coupled to the exhaust aftertreatment system 224 and is configured to either 1) increase the temperature of the exhaust gas flowing through the exhaust aftertreatment system 224) increase the temperature of one or more components of the exhaust aftertreatment system 224. Raising the temperature of the exhaust gas and/or the exhaust aftertreatment system 224 with the heater 226 may increase the efficiency of one or more catalysts of the exhaust aftertreatment system 224. The aftertreatment system heater 226 may be a grid heater, a heater within the exhaust aftertreatment system 224 (e.g., directly coupled to a catalyst of the exhaust aftertreatment system 224), an induction heater, or a microwave heater.

The heater 226 may be a grid heater that may include an electrically conductive mesh configured to fit within the flow of the exhaust gas that allows the exhaust gas to flow through the mesh structure. The mesh structure can be, for example, a resistive heater that increases in temperature when coupled to an electric power source. The grid heater heats the gas, which in turn transfers heat to a catalyst of the exhaust aftertreatment system 224. As the exhaust gas flows through the grid heater, the temperature of the exhaust gas increases via convection.

A heater within the SCR system may include an electric heater embedded within, or otherwise coupled to, the catalyst substrate. The electric heater may be a resistive heater or any other type of suitable electric heater capable of heating the exhaust gas as it flows through the SCR system.

An induction heater may include an electrically conductive structure configured to fit within the flow of the exhaust gas that allows the exhaust gas to flow through or around the structure. The structure is coupled to an electromagnet connected to a power source. The power source induces a high-frequency alternating current through the electromagnet, which generates current through the structure, causing the structure to heat up. As exhaust gas flows through the structure, the temperature of the exhaust gas increases via convection.

A microwave heater may include an electromagnetic radiation source in communication with the exhaust gas. The electromagnetic radiation source may rapidly vary electric and magnetic fields, causing the exhaust gas to increase in temperature.

Referring generally to the engine sensors 230, the air sensors 240, and the external sensors 270, the sensors of the vehicle 202 are structured to detect and/or determine operational data associated with the vehicle 202. The operational data may include the vehicle information stored by the remote computing system 110, as described above with respect to FIG. 1.

As shown in FIG. 2, the engine sensors 230 include a fuel sensor 232, a fuel consumption sensor 234, and a cylinder sensor 236. The engine sensors 230 are structured to detect operational data associated with the vehicle 202 and particularly the engine. For example, the engine sensors 230 may detect an engine speed, a torque, a load, fueling information, etc. As described above, the sensors may also include other sensors that detect/determine a vehicle speed, a vehicle acceleration, a brake health, voltage and/or current for an electric motor and/or battery, fault or diagnostic code information, and/or any other operational data related to the engine 210, a power delivery system such as the battery 250, and/or other components/systems of the vehicle. The sensors may further detect a value for a vehicle weight (e.g., a gross vehicle weight), a vehicle location based on a GPS signal and/or a total or partial distance traveled, a vehicle speed, and/or a vehicle acceleration.

The detected or determined information may also include emissions values, such as a NOx value (e.g., a cumulative NOx output over a predefined amount of time and/or distance, an instantaneous NOx output, a NOx reading at various places within the system such as an engine out NOx amount versus an aftertreatment system NOx output amount, a NOx output rate over time and/or distance, etc.), output of an engine (e.g., the engine 210), a NOx output of a system (e.g., the vehicle 202, the fleet 200), etc. The detected or determined information may also include a particulate matter output, such as a cumulative particulate matter output. The detected or determined information may also include GHG values, such as a cumulative GHG output. Additionally, the detected or determined information may also include a fuel efficiency value (e.g., average over a predefined time or distance, instantaneous, etc.) and/or any other operational data associated with a cylinder (e.g., cylinder 212), engine (e.g., engine 210), vehicle (e.g., vehicle 202), and/or fleet 200. The cumulative values may be defined for a period, which may be based on a predefined amount of time (e.g., an operating time, a time between a predetermined start and endpoint, a distance, operating hours, etc.) and/or distance (a predefined distance in miles, kilometers or other unit of distance). The cumulative values may be associated with a given route, within a defined territory (e.g., state, region, etc.), etc.

The predicted information may also include a predicted and/or simulated fleet outcome. The predicted fleet outcome may be compared against a fleet target (e.g., a fleet goal). For example, the fleet target may be a 30% GHG reduction goal relative to an initial starting point, and the predicted fleet outcome may be compared against the fleet target. The simulated fleet outcome(s) may include a predicted output for a defined period (e.g., an operating time, hours, or miles), a given route, a defined territory (e.g., geographical area, state, etc.), etc. In some embodiments, the simulated fleet outcome may also include a predicted output in consideration of differing WTT inputs including grid electricity versus electricity generated by an ICE, electricity from renewable versus electricity from non-renewable sources, and/or electricity from fossil fuel (e.g., diesel, natural gas, etc.). The simulated fleet outcome may also include predicted operational costs based on a period, a route, and/or a territory.

Any of the detected, estimated, or otherwise acquired data described herein may be compared to a threshold value. In some embodiments, the threshold value may be a regulatory threshold set by a government agency, a regulatory body, etc. In some embodiments, the threshold value may be a goal threshold set by a vehicle owner/operator, a third party stakeholder, etc.

In the embodiment shown, the engine sensors 230 include specialized sensors for detecting particular information. For example, the fuel sensor 232 is structured to detect a fuel storage level, a fuel mixture, and/or other parameters related to fuel entering the engine 210. The fuel sensor 232 detects an amount of fuel remaining (e.g., in gallons, liters, percentage of full, etc.). When the vehicle is embodied as an at least partially hybrid vehicle (e.g., full electric, plug-in electric, hybrid, etc.), the fuel sensor 232 detects an amount of battery charge remaining (e.g., in ampere hours, watt hours, estimated vehicle range, percentage of full, etc.) (i.e., in this embodiment, the sensor may be a state-of-charge sensor). The fuel consumption sensor 234 is structured to detect an amount of fuel being used by the engine 210. For example, the fuel consumption sensor 234 is structured to detect an amount of fuel being used over time. The fuel consumption sensor 234 detects a fuel usage rate (e.g., gallons per mile, miles per gallon, gallons per hour, etc.). When the engine 210 includes an electric engine, the fuel consumption sensor 234 detects a battery charge usage rate (e.g., battery charge percentage per mile, miles per battery charge percentage, etc.). In these embodiments, the fuel consumption sensor 234 is also structured to detect a recharging rate (e.g., regenerative recharging, solar recharging, etc.) of the battery 250.

The cylinder sensor 236 is structured to detect operational data associated with the cylinders 212. For example, the cylinder sensor 236 is structured to detect an operational efficiency of an individual cylinder 212 and/or of all active cylinders 212. The operational efficiency may include a fuel consumption rate per unit of time, per unit of emissions (e.g., unit or concentration of NOx, GHG, or other emissions), per distance traveled (e.g., miles or kilometers), and/or other engine parameters for an individual cylinder 212. In some embodiments, when the cylinders 212 are each selectively operable such that individual cylinders, or groups of cylinders are structured to be activated or deactivated, the cylinder sensor 236 are structured to detect operational efficiencies of active cylinders. The cylinder sensor 236 is structured to detect, for example, a fuel mixture, a timing, and/or any other operational data associated with the operation of a single cylinder or a group of cylinders.

As shown in FIG. 2, the air sensors 240 include a NOx sensor 242, a particulate sensor 244, and a GHG sensor 246. In some embodiments, the air sensors 240 also include temperature sensors, pressure sensors, flow rate sensors, and/or any other sensor for detecting a parameter of the air. The air sensors 240 are structured to detect operational data associated with the vehicle 202 such as a concentration of engine emissions in exhaust gasses. For example, the NOx sensor 242 is structured to detect a concentration of nitrogen oxide in exhaust gasses. The particulate sensors 244 are structured to detect a concentration of particulate matter in exhaust gasses. The GHG sensor is structured to detect a concentration of greenhouse gasses in exhaust gasses. In some embodiments, the air sensors 240 includes a combination sensor structured to detect NOx, particulate matter and GHG in exhaust gasses. In some embodiments, the air sensors 240 are positioned at various locations throughout the system, such as at an engine inlet, at a position upstream of a first catalyst (DOC), between a first catalyst and a second catalyst (SCR), and/or downstream from second catalyst (e.g., SCR catalyst), etc.

The battery 250 is structured to provide electric power to the components of the vehicle 202 directly or indirectly (e.g., via the controller 300). In some hybrid or electric vehicle type scenarios, the battery 250 provides power to one or more electric motors of the vehicle 202 that power or propel the vehicle 202. In some embodiments, the battery 250 is structured to be charged by an alternator (e.g., when the engine 210 is an ICE), regenerative power, solar power, and/or an external power source.

The fuel system(s) 260 is structured to provide fuel to the engine 210. For example and depending on the engine type, the fuel system(s) 260 are structured to store a fuel such as gasoline, diesel, hydrogen fuel, hydrogen fuel cell, etc. and provide the fuel to the engine 210. One or more of the sensors (e.g., the fuel sensor 232) is coupled to the fuel systems such that the sensors are operable to detect a fuel storage level and/or a fuel mixture being provided to the engine 210.

As shown in FIG. 2, the external sensors include a positioning sensor 272 and an ambient sensor 274. The external sensors 270 are structured to detect operational data associated with the vehicle 202. For example, the positioning sensor 272 is structured to detect a location of the vehicle 202. Accordingly, the positioning sensor 272 includes a one or more receivers for communicating with a global positioning system (GPS), a cellular network, or any other suitable location positioning system. The ambient sensor 274 is structured to detect and/or receive ambient information from outside the vehicle 202. In some embodiments, the ambient sensor 274 includes one or more of the air sensors 240 for detecting ambient NOx, particulate matter, and GHG. In some embodiments, the ambient sensor 274 detects an ambient temperature, atmospheric pressure, humidity, and/or any other ambient parameter. In some embodiments, the ambient sensor 274 includes a wireless transceiver that is structured to receive a data signal including ambient data from an off-vehicle computing system (e.g., the remote computing system 110 and/or the third party computing system 190). The ambient data may include any ambient parameter including ambient temperature, atmospheric pressure, humidity, weather information, historical ambient data and/or predicted ambient data.

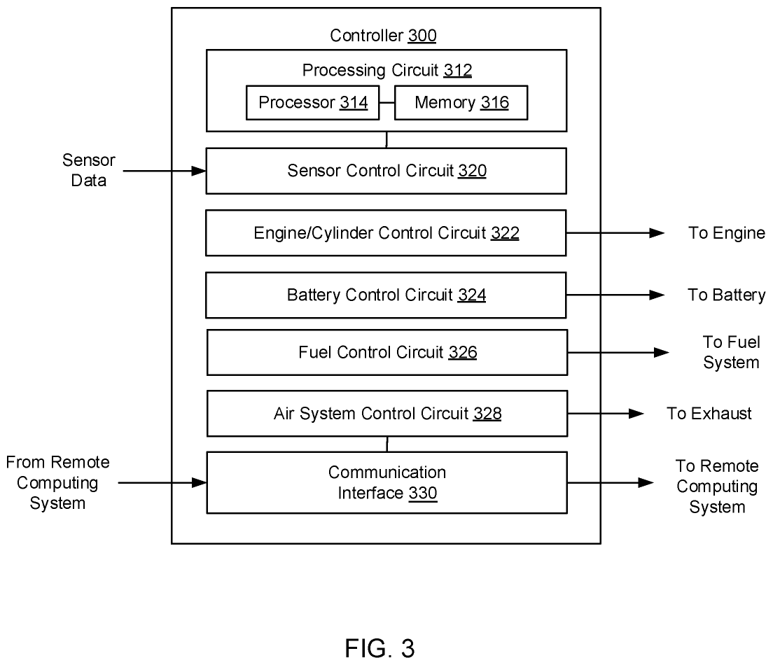

As shown in FIG. 2, the controller 300 is operatively and communicatively coupled to various components of the vehicle 202. The controller 300 is structured to control the operation of each of the components of the vehicle 202 by providing one or more commands to the components. For example, the controller 300 is structured to change an operational parameter of the engine 210, the air system 220, the battery 250, and/or the fuel systems 260. The controller 300 is also structured to receive information, such as data signals, from various components and/or systems of the vehicle 202. For example, the controller 300 can receive data from the engine sensors 230, the air sensors 240, and/or the external sensors 270. The controller 300 is described in further detail herein below with respect to FIG. 3.

FIG. 3 is a block diagram of a controller 300 of the vehicle 202 of FIG. 2, according to an example embodiment. As shown, the controller 300 includes a processing circuit 312, and one or more specialized processing circuits shown as a sensor control circuit 320, an engine/cylinder control circuit 322, a battery control circuit 324, a fuel control circuit 326, and an air system control circuit 328, and a communications interface 330. In some embodiments, the controller 300 may include more or fewer control circuits than as shown in FIG. 3. In some embodiments, the controller 300 is a control system for the vehicle 202 and is at least partially integrated with one or more other sub-control systems such as an engine control module (ECM), transmission control module, powertrain control module, aftertreatment system control module, etc. For example, the controller 300 may be structured to include the entirety of the ECM or include only a portion of the ECM. In other embodiments, the controller 300 is substantially separate from other control systems. For example, the controller 300 and an ECM are separate control systems, but may be communicatively and/or operatively coupled.

The controller 300 may be structured as one or more electronic control units (ECU). In one embodiment, the components of the controller 300 are combined into a single unit. In another embodiment, one or more of the components may be geographically dispersed throughout the system. All such variations are intended to fall within the scope of the disclosure.

In one configuration, the specialized processing circuits are embodied as machine or computer-readable media storing instructions that are executable by a processor, such as processor 314. As described herein and amongst other uses, the instructions of the machine-readable media facilitates performance of certain operations to enable reception and transmission of data. For example, the machine-readable media may provide an instruction (e.g., command, etc.) to, e.g., acquire data. In this regard, the machine-readable media may include programmable logic that defines the frequency of acquisition of the data (or, transmission of the data). As described herein, the computer readable media may include or store code, which may be written in any programming language including, but not limited to, Java or the like and any conventional procedural programming languages, such as the “C” programming language or similar programming languages. The computer readable program code may be executed on one processor or multiple remote processors. In the latter scenario, the remote processors may be connected to each other through any type of network (e.g., CAN bus, etc.).

In another configuration, the specialized processing circuits are embodied as hardware units, such as electronic control units. As such, the specialized processing circuits may be embodied as one or more circuitry components including, but not limited to, processing circuitry, network interfaces, peripheral devices, input devices, output devices, sensors, etc. In some embodiments, the sensor control circuit 320, the engine/cylinder control circuit 322, the battery control circuit 324, the fuel control circuit 326, and/or the air system control circuit 328 may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on). The specialized processing circuits may also include programmable hardware devices such as field programmable gate arrays, programmable array logic, programmable logic devices or the like. The power specialized processing circuits may include one or more memory devices for storing instructions that are executable by the processor(s) of the specialized processing circuits. The one or more memory devices and processor(s) may have the same definition as provided below with respect to the memory device 316 and processor 314. In some hardware unit configurations and as described above, the specialized processing circuits may be geographically dispersed throughout separate locations in the system. Alternatively and as shown, the specialized processing circuits may be embodied in or within a single unit/housing, which is shown as the controller 300.

In the example shown, the controller 300 includes the processing circuit 312 having the processor 314 and the memory device 316. The processing circuit 312 may be structured or configured to execute or implement the instructions, commands, and/or control processes described herein with respect to the specialized processing circuits. The depicted configuration represents the specialized processing circuits as instructions such that they may be stored and executed by the memory device 316. However, as mentioned above, this illustration is not meant to be limiting as the present disclosure contemplates other embodiments where the specialized processing circuits, or at least one circuit of the circuits the specialized processing circuits, is configured as a hardware unit. All such combinations and variations are intended to fall within the scope of the present disclosure

The processing circuit 312 is coupled to the specialized processing circuits and/or the communications interface 330. The processing circuit 312 includes a processor 314 and a memory 316. The memory 316 is one or more devices (e.g., RAM, ROM, Flash memory, hard disk storage) for storing data and/or computer code for completing and/or facilitating the various processes described herein. The memory 316 is or includes non-transient volatile memory, non-volatile memory, and non-transitory computer storage media storing instructions that are executable by the processor 314. The memory 316 includes database components, object code components, script components, or any other type of information structure for supporting the various activities and information structures described herein. The memory 316 is communicatively coupled to the processor 314 and includes computer code or instructions for executing one or more processes described herein. The processor 314 is implemented as one or more application specific integrated circuits (ASICs), field programmable gate arrays (FPGAs), a group of processing components, or other suitable electronic processing components. As such, the controller 300 is configured to run a variety of application programs and store associated data in a database of the memory 316.

The communications interface 330 is structured to receive communications from and provide communications to other computing devices, sensors, and the like coupled to the controller 300. The communications interface 330 is structured to exchange data, communications, instructions, and the like with an input/output device of the components of the vehicle 202. In some arrangements, the communications interface 330 includes communication circuitry for facilitating the exchange of data, values, messages, and the like between the communications interface 330 and the components of the controller 300. In some arrangements, the communications interface 330 includes machine-readable media for facilitating the exchange of information between the communications interface 330 and the components of the controller 300. In some arrangements, the communications interface 330 includes any combination of hardware components, communication circuitry, and machine-readable media.

As alluded to above, the controller 300 may be structured to include the entirety of the communications interface 330 or include only a portion of the communications interface 330. In these latter embodiments, the communications interface 330 is communicatively coupled to the processing circuit 312 and/or other components of the controller 300. In other embodiments, the controller 300 is substantially separate from the communications interface 330. For example, the controller 300 and the communications interface 330 are separate control systems, but may be communicatively and/or operatively coupled.

The communications interface 330 may include any combination of wired and/or wireless interfaces (e.g., jacks, antennas, transmitters, receivers, transceivers, wire terminals) for conducting data communications with various systems, devices, or networks structured to enable in-vehicle communications (e.g., between and among the components of the vehicle) and out-of-vehicle communications (e.g., directly with remote computing system 110). In this regard, in some embodiments, the communications interface 330 includes a network interface. The network interface is used to establish connections with other computing devices by way of the network 105. The network interface includes program logic that facilitates connection of the controller 300 to the network 105. The network interface includes any combination of a wireless network transceiver (e.g., a cellular modem, a Bluetooth transceiver, a Wi-Fi transceiver) and/or a wired network transceiver (e.g., an Ethernet transceiver). For example, the communications interface 330 includes a wireless device such as a cellular transceiver and machine-readable media such as a cellular driver configured to facilitate connections with the network 105. In some arrangements, the network interface includes the hardware and machine-readable media sufficient to support communication over multiple channels of data communication. Further, in some arrangements, the network interface includes cryptography capabilities to establish a secure or relatively secure communication session in which data communicated over the session is encrypted. For example and regarding out-of-vehicle/system communications, the communications interface 330 may include an Ethernet card and port for sending and receiving data via an Ethernet-based communications network and/or a Wi-Fi transceiver for communicating via a wireless communications network. The communications interface 330 may be structured to communicate via local area networks and/or wide area networks (e.g., the Internet) and may use a variety of communications protocols (e.g., IP, LON, Bluetooth, ZigBee, and radio, cellular, near field communication). Furthermore, the communications interface 330 may work together or in tandem with a telematics unit, if included, in order to communicate with other vehicles in the fleet and/or the remote computing system. In one example embodiment, the communications interface 330 is structured provide vehicle information (e.g., operational parameters and/or operational data) to the remote computing system 110, the third party computing systems 190, and/or other vehicles in the fleet 200.

In an example embodiment, the communications interface 330 is structured to communicate with and/or receive instructions from the remote computing system 110, the third party computing systems 190, and/or other vehicles in the fleet 200. For example, the communications interface 150 is structured to transmit data (e.g., sensor data) from the components of the controller 300 to the remote computing system 110, the third party computing systems 190, and/or other vehicles in the fleet 200.

Now referring to the specialized processing circuits (e.g., the sensor control circuit 320, the engine/cylinder control circuit 322, the battery control circuit 324, the fuel control circuit 326, and the air system control circuit 328), the specialized processing circuits are structured to control one or more operational parameters of the vehicle 202 among other activities. As described above, the specialized processing circuits may include hardware, software, or any combination thereof for controlling the operational parameters of the vehicle 202. Accordingly, the controller 300 can change operational parameters of the vehicle 202 by using one or more of the specialized processing circuits. For example, the controller 300 (or one or more of the specialized processing circuits thereof) may generate a control signal and transmit the control signal to a component of the vehicle 202. The control signal may cause the component to change (e.g., increase, decrease, etc.) an operational parameter of the vehicle 202.

The sensor control circuit 320 is structured to receive sensor data from the sensors of the vehicle 202. For example, the sensor control circuit 320 receives sensor data including operational parameters, such as a fuel consumption rate, a NOx value, a GHG value, a particulate matter value, and/or another exhaust gas constituent value in exhaust gasses (e.g., as described with respect to the sensor data above). The sensor control circuit 320 is also structured to provide the sensor data to the other components of the controller 300. The sensor control circuit 320 is also structured to provide the sensor data to the remote computing system 110, the third party computing systems 190, and/or other vehicles in the fleet 200 (e.g., via the communications interface 330). In some embodiments, the sensor control circuit 320 may also be structured to control the operation of one or more sensors. For example, the sensor control circuit 320 may be structured to generate one or more control signals and transmit the control signals to one or more sensors (e.g., to acquire data, etc.). The control signals may cause the one or more sensors to sense and/or detect the sensor data and/or provide the sensor data to the sensor control circuit 320.

The engine/cylinder control circuit 322 is structured control operational parameters of the engine 210 and/or one or more of the cylinders 212. For example, the engine/cylinder control circuit 322 is structured to adjust an operational parameter of the engine 210 such as an engine speed, an engine torque, valves for the engine (open/closing of intake/exhaust valves to, for example, implement CDA), and/or any other operational parameter of the engine 210. For example, in some embodiments, the engine/cylinder control circuit 322 may be structured to generate one or more control signals and transmit the control signals to the engine 210 (e.g., to one or more of the cylinders 212). The control signals may cause the engine 210 and/or one or more of the cylinders 212 to change one or more operational parameters described herein. For example, the engine/cylinder control circuit 322 may be structured to control the operation of individual cylinders 212 or groups of cylinders 212 during a CDA operating mode, such as dynamic skip fire. As described above, the dynamic skip fire includes the engine/cylinder control circuit 322 selectively deactivating individual cylinders 212 or groups of cylinders 212 (e.g., to conserve fuel, to evaluate a performance of one or more cylinders 212, reduce emissions, etc.) on a cycle-by-cycle basis. Accordingly, the control signals generated and/or transmitted by the engine/cylinder control circuit 322 may include instructions for the dynamic skip-fire operation mode.

In some embodiments, when the engine 210 is a hybrid engine 210 (e.g., a mild-hybrid engine, etc.) the engine/cylinder control circuit 322 may be configured to cause the hybrid engine 210 to change between different modes of operation. For example, a first mode of operation may include using only an internal combustion engine portion of the hybrid engine 210 to propel the vehicle 202, a second mode of operation may include using only a battery-electric motor of the hybrid engine 210 to propel the vehicle, and a third mode of operation may include using both the internal combustion engine and the battery-electric motor of the hybrid engine 210 to propel the vehicle 202. The battery control circuit 324 is structured to control the operational parameters of the battery 250 (e.g., charge/discharge rates and/or amounts from the battery 250, etc.). In some embodiments, the battery control circuit 324 may be structured to generate one or more control signals and/or transmit the control signals to the battery 250. The control signals may cause the battery 250 to change an operational parameter. For example the battery control circuit 324 is structured to selectively facilitate providing power to one or more of the components of the vehicle 202 via the battery 250, for example, by providing control signals to the battery to electrically couple the battery 250 to one or more of the components of the vehicle 202. The battery control circuit 324 is also structured to facilitate charging the battery 250, for example, by causing a current to flow into the battery 250.

The fuel control circuit 326 is structured to control the operational parameters of the fuel systems 260. In some embodiments, the fuel control circuit 326 may be structured to generate one or more control signals and/or transmit the control signals to the fuel systems 260. The control signals may cause the fuel systems 260 to change an operational parameter. For example, the control signals provided by the fuel control circuit 326 may cause the fuel systems 260 to change a fuel-to-air mixture ratio. As another example, the fuel control circuit 326 may control a rail pressure in a common rail (if the fueling system includes a common rail), a fuel injection quantity and/or timing, and other aspects associated with the fueling system.

The air system control circuit 328 is structured to control the operational parameters of the air system 220. In some embodiments, the air system control circuit 328 may be structured to generate one or more control signals and/or transmit the control signals to the air system 220. The control signals may cause the air system 220 to change an operational parameter. For example, the control signals generated by the air system control circuit 328 may cause the air system 220 to change an intake flow rate or amount at the intake 228, an exhaust flow rate or amount at the exhaust 222, and/or other operational parameters associated with the air system 220.

In some embodiments and as alluded to above, the controller 300 may include additional control circuits. In an example embodiment, the circuitry (e.g., hardware, software, or combination thereof) of the additional control circuits may be operated physically remotely from the controller 300 and/or may be at least partially integrated with the controller 300.

In an example embodiment, the controller 300 may include additional control circuits for controlling operational parameters of the exhaust heater 226 and/or the exhaust aftertreatment system 224 (e.g., dosing amounts, dosing timing, flow rates, etc.). The additional control circuitry may generate and/or transmit control signals to the exhaust aftertreatment system 224 and/or the exhaust heater 226. The control signals may cause the exhaust heater 226 by turning on the exhaust heater 226 to increase temperature of exhaust gasses or turning off the exhaust heater 226 to decrease the temperature of exhaust gasses.

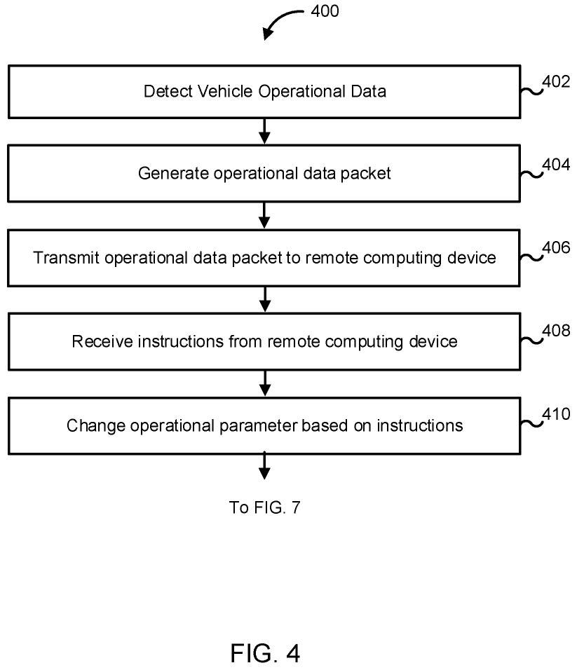

Referring to FIGS. 4-7, various flow diagrams of methods are shown according to various example embodiments. It should be understood that although the figures or description refers to a single vehicle (e.g., the vehicle 202 of FIG. 2), the methods described herein below are applicable to any vehicle of the fleet 200.

FIG. 4 is a flow diagram of a method 400 of managing operational parameters of the vehicle 202 of FIG. 2, according to an example embodiment. In some embodiments, one or more of the computing systems of the system 100 is configured to perform method 400. For example, the remote computing system 110, the third party computing system 190, and/or the controller 300 may be structured to perform the method 400. In the depicted example embodiment, the controller 300 performs the method 400, alone or in combination with other devices such as the remote computing system 110 and the third party computing systems 190. The method 400 may include user inputs from a user (e.g., a provider employee, a third-party employee, a customer, a vehicle operator, etc.) of one or more user devices (such as devices of provider employees, customer, a user device integrated with a vehicle, etc.), another computing device on the network 105, etc.

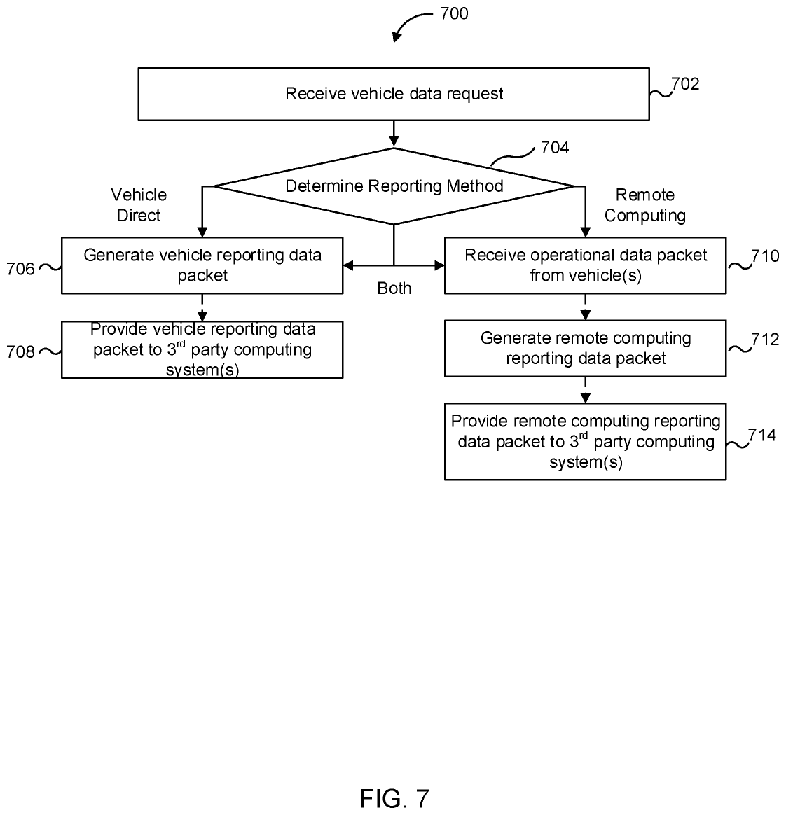

As an overview of method 400, at process 402, vehicle operational data is detected, received, and/or acquired. At process 404, an operational data packet is generated. At process 406, the operational data packet is transmitted to the remote computing system 110. At process 408, instructions are received from the remote computing system 110. At process 410, one or more operational parameters are changed based on the instructions. In some embodiments, after process 410, the method 400 may continue with process 702, shown in FIG. 7. In some arrangements, the processes of the method 400 may be performed in a different order than as shown in FIG. 4. In some arrangements, the method 400 may include more or fewer processes than as shown in FIG. 4.

Referring to the method 400 in more detail, at process 402, vehicle operational data is detected. For example, the sensors of the vehicle 202 (e.g., the engine sensors 230, the air sensors 240, and the external sensors 270, etc.) detect vehicle operational data (e.g., emissions information) which may include one or more operational parameters of the vehicle 202 and/or any of the information described herein. The sensors may detect any of the vehicle operational data including the one or more operational parameters described herein above and provide the sensor data to the controller 300 via the sensor control circuit 320.

At process 404, an operational data packet is generated. The controller 300 generates an operational data packet. The operational data packet includes the vehicle operational data sensed, detected and/or acquired by the sensors (e.g., the sensor data) including one or more operational parameters, as described above in process 402. The operational data packet may also include a vehicle identifier and/or an engine identifier, such as a VIN, a serial number, etc. The operation data packet may also include historical data and/or trend data such as sensor data over time, sensor data per mile, sensor data for a route or portion of a route, etc. Accordingly the operational data packet may include time data, location data, route information, operator information, and/or any of the information described herein above. The operational data packet may be generated (e.g., compiled, aggregated, etc.) by the controller 300 and is specific to the vehicle.

The operational data packet may include an emissions data packet. The emissions data packet may include emissions information, as described herein, regarding the vehicle 202. Certain emissions information may be determined by the controller 300 (e.g., NOx conversion rate, PM cumulative amounts) while other information may be determined by the remote computing system (e.g., PM cumulative amount relative to a standard to determine compliance or non-compliance). In some embodiments, the controller 300 itself may store certain information (e.g., compliance thresholds) and make certain determinations itself rather than the remote computing system 110. Thus, the emissions data packet may generally refer to a data packet containing emissions information.

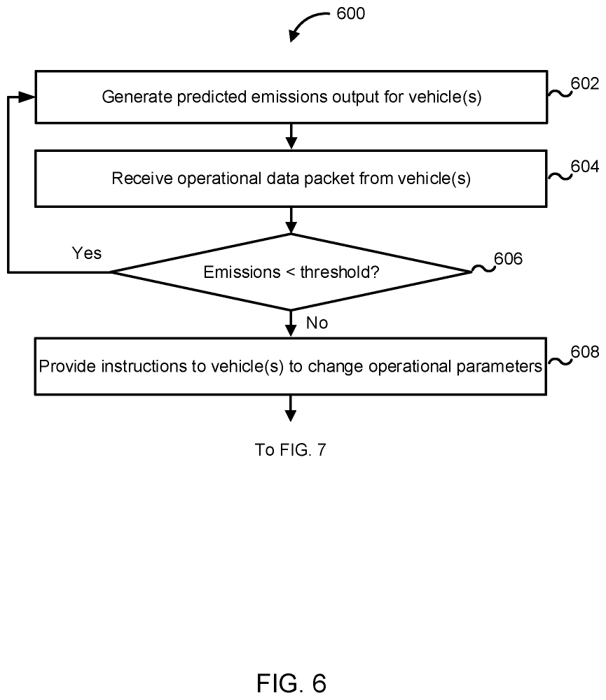

At process 406, the operational data packet is transmitted to the remote computing system 110. The controller 300 is structured to transmit the operation data packet via the communications interface 330 to the remote computing system 110. Based on the received operational data packet, at process 408, instructions are received form the remote computing system 110. The controller 300 is structured to receive the instructions via the communications interface 330. The instructions include control signals that instruct the controller 300 to change one or more operational parameters. In some embodiments, the instructions are generated by the remote computing system 110 as described in detail herein below with respect to FIG. 6. In other embodiments, the controller 300 generates the instructions such that process 408 additionally and/or alternatively includes generating, by the controller 300, the instructions.

At process 410, the one or more operational parameters are changed. The controller 300 is structured to change one or more operational parameters based on the instructions received from the remote computing system 110. For example the controller 300 is structured to change an engine/cylinder parameter by the engine/cylinder control circuit 322, a battery parameter by the battery control circuit 324, a fuel parameter by the fuel control circuit 326, and/or an air system parameter by the air system control circuit 328 (among others).

More specifically, the instructions may include adjusting a fuel injection quantity, a fuel injection timing, fuel injection events (single versus multiple), and other fuel injection parameters for an engine 210. The instructions may also include adjusting a VGT position, an EGR valve positioning to control a flow rate/amount of EGR, an intake valve timing, an exhaust valve timing, adjusting a throttle, bypassing a CAC and/or EGR, etc. of the air system 220. The instructions may also include adjusting a fuel blend (diesel, natural gas, hydrogen, propane, etc.) by the fuel system 260. The instructions may also include causing the engine 210 to utilize a CDA operating mode, such as dynamic skip fire (DSF). The DSF operating mode may increase exhaust gas temperatures thereby reducing NOx output as well as reduce fuel consumption. The controller 300 and/or the remote computing system 110 may determine, based on the sensor data, that one or more of the cylinders 212 has a lower combustion temperature on average, a lower pressure, a lower power output, a higher emissions output, and/or other potentially non-compliant or non-desired operating data. For example, the controller 300 and/or the remote computing system 110 may determine that one or more cylinders 212 out of a first grouping of cylinders 212 has non-compliant operational data values and/or different operational data values than second grouping of cylinders 212 which indicates that one or more of the cylinders 212 of the first grouping may be not operating as intended.

The instructions may also include adjusting the exhaust heater 226 temperature to increase exhaust gas and/or aftertreatment system component temperatures thereby promoting catalyst activity to reduce NOx output.

The instructions may also include adjusting operation of the engine 210 (e.g., an ICE) in response to an engine status (e.g., on, off, idle, load amount, temperature, etc.), an emissions output (e.g., emissions values including concentration, cumulative amount, etc.), an engine health (based on OBD information), etc.

The instructions may also include adjusting operation of an electric motor in response to an electric motor status or condition (e.g., on, off, idle, load amount, temperature, etc.), an emissions output (e.g., emissions values including concentration, cumulative amount, etc.), battery and/or motor health (based on OBD), etc.

The instructions may also include causing a hybrid engine 210 to change between one or more modes of operation (e.g., between a battery-electric mode, an internal combustion engine mode, etc.) based on an emissions output from the vehicle. For example and with a mild hybrid vehicle, when the emissions value is above a predefined threshold (e.g., NOx output above a maximum defined limit), the instructions may cause a change in operational parameter including activation of an electric heater to promote SCR catalytic activity. If the emissions value stays above the predefined threshold, the instructions may cause switching of modes of operation of the mild hybrid vehicle from a first mode (internal combustion engine only) to a second mode (e.g., electric motor only). By switching to an electric motor only mode of operation, the emissions output may be effectively managed. This mode of operation may continue until, for example, an emergency scenario is detected. In this regard, the instructions may account for emergency scenarios such as a depleted fuel source (e.g., an amount of fuel remaining being below a threshold level, a state-of-charge of the battery 250 being at or below a predefined state-of-charge threshold value, etc.), a faulty component that needs repair, and/or other emergency scenarios. With respect to the above example, if the battery SOC depletes to at or below a predefined threshold value, then the controller may cause the first mode of operation (or, in some embodiments, a third mode of operation that utilizes both the internal combustion engine and the electric motor depending on if the battery SOC is above a critically low level).

In other embodiments, one or more modes of operation may include adjusting an operational parameter including an engine-to-electric battery load. The engine-to-electric battery load may be adjusted based on at least one of the engine status, an engine health, the first predicted set of emissions values, or the first actual set of emissions values. For example, the engine-to-electric battery load may be increased responsive to determining that the emissions value is below a predefined threshold. The engine-to-electric battery load may be decreased responsive to determining that the emissions value is above a predefined threshold. In some embodiments, the change to the engine-to-electric battery load may continue until, for example, an emergency scenario is detected.

Accordingly, the controller 300 may switch between different modes of operation based on operational data (e.g., emissions values), threshold values for operational data, and/or emergency scenarios. In some embodiments, the controller 300 may be configured to cause the hybrid engine 210 to switch between modes of operation based the operational data values (e.g., emissions values) continuing to exceed threshold values after changing other operational parameters (e.g., the operational parameters described above). For example, the controller 300 may cause a hybrid engine 210 to change to a battery-electric mode based on an emissions value exceeding a threshold after other operational parameters were already changed. As briefly described above, the method 400 may continue to the method 700 after process 410.

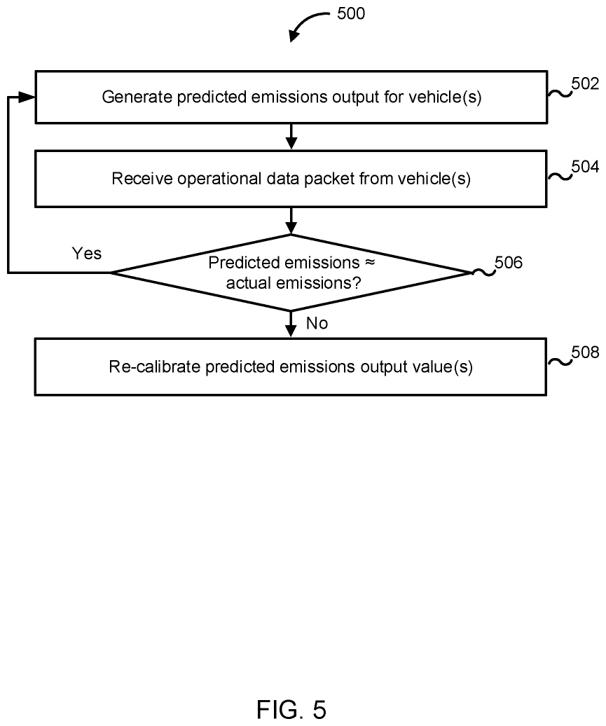

FIG. 5 is a flow diagram of a method of recalibrating predicted emissions values for the vehicle 202 of FIG. 2, according to an example embodiment. In some embodiments, one or more of the computing systems of the system 100 is configured to perform method 500. For example, the remote computing system 110, the third party computing system 190, and/or the controller 300, may be structured to perform the method 500. In the depicted example embodiment, the remote computing system 110 performs the method 500, alone or in combination with other devices such as the controller 300 and the third party computing systems 190. In additional and/or alternative embodiments the method 500 may be performed by the controller 300. The method 500 may include user inputs from a user (e.g., a provider employee, a third-party employee, a customer, a vehicle operator, etc.) one or more user devices (such as devices of provider employees, customer, a user device integrated with a vehicle, etc.), another computing device on the network 105, etc.

As an overview of method 500, at process 502, a predicted emissions output for one or more vehicles (202, 204, 206) is generated. At process 504, an operational data packet is received from one or more vehicles (202, 204, 206). At process 506, the predicted emissions output is compared to the actual emissions of the one or more vehicles (202, 204, 206). At process 508, the predicted emissions output value(s) is re-calibrated (e.g., re-calibration of predicted NOx values at various locations such as system-out, engine-out, etc.; re-calibration of predicted PM values at various locations such as system-out, engine-out, etc.; etc.). In some arrangements, the processes of the method 500 may be performed in a different order than as shown in FIG. 5. For example, processes 502 and 504 may be performed in any order, sequentially, concurrently, and/or partially concurrently. In some arrangements, the method 500 may include more or fewer processes than as shown in FIG. 5.

Referring to the method 500 in more detail, at process 502, a predicted emissions output for one or more vehicles (202, 204, 206) is generated. The remote computing system 110 is structured to generate one or more predicted output values for the vehicles (202, 204, 206) of the fleet 200. For example, the modeling circuit 140, and components thereof, is structured to utilize data received by the vehicle tracking circuit 148 (e.g., via the communications interface 150) and/or stored by the vault 130 to generate a computer-generated prediction of one or more values. For example, the modeling circuit 140 may generate a predicted value regarding a vehicle weight (e.g., a gross vehicle weight), a vehicle location based on a GPS signal, a total distance traveled, a vehicle speed, and/or a vehicle acceleration.

The values may also include a NOx value (or other emissions value, such as PM, GHG, etc.) regarding one or more vehicles (e.g., a cumulative NOx output over a predefined amount of time (e.g., operating time, hours, etc.) and/or distance (e.g., a predefined amount of miles), an instantaneous NOx output, a NOx reading at various locations such as an engine out NOx amount versus an aftertreatment system NOx output amount, a NOx output rate over time and/or distance, etc.), a NOx output of a system (e.g., the vehicle 202, the fleet 200), etc. Similarly, the emissions value may include an instantaneous particulate matter output, a cumulative particulate matter output, a cumulative GHG output, and/or any other operational data associated with a cylinder (e.g., cylinder 212), engine (e.g., engine 210), vehicle (e.g., vehicle 202), and/or fleet 200. The cumulative values are defined for a period (e.g., an operating time, a time between a predetermined start and endpoint, a distance, etc.), which may be associated with a route and/or location of the system (e.g., state, region, etc.). In any of the above described embodiments, the predicted emissions values (e.g., NOx values, GHG values, cumulative values, etc.) may be determined based on at least one of a model (e.g., a statistical model, a lookup table, a machine learning model, etc.), as described herein with respect to the modeling circuit 140.

In some embodiments, the predicted values may also include and/or consider differing well-to-tank inputs (e.g., emissions due to production and transport of fuel). For example, the predicted values may be based on and/or consider an electric power source (e.g., grid electricity versus electricity generated by an ICE), electricity from renewable and non-renewable source, fuel or electricity created from or using fossil fuels such as diesel, natural gas, hydrogen, etc. For example, the predicted emissions values (e.g., NOx, GHG, etc.) may include at least one well-to-tank emissions value of a fuel input. As described herein, the fuel may be gasoline, diesel, hydrogen, etc. and/or an electric fuel (e.g., electrical charge, battery charge, electricity, etc.). In some embodiments, the at least one well-to-tank emissions value of the fuel input is based on receiving, by the remote computing system 110, at least one of a gasoline well-to-tank emissions value, a diesel well-to-tank emissions value, a hydrogen well-to-tank emissions value (e.g., for a hydrogen fuel engine and/or a hydrogen fuel cell engine), and/or other fuel source well-to-tank emissions value. In some embodiments, the at least one well-to-tank emissions value may be received from a third party computing system. For example, the received well-to-tank emissions values may include an emissions amount of an exhaust gas species (e.g., mass, volume, concentration, etc. of NOx, GHG, particulate matter, etc.) per unit of fuel (e.g., gallon, liter, etc.). More specifically, the received well-to-tank emissions values may correspond to the fuel received by a fuel system 260 of the vehicle 202.

Although the embodiments described herein are related to a “well to tank” emissions value, it should be understood that any of the embodiments described herein may use a “well to wheel” emissions value. As used herein the “well-to-wheel” emissions value encompasses the well to tank emissions value plus an emissions value of the emissions value of using (e.g., combusting) the fuel in the engine 210. In some embodiments, the predicted emissions values described above may be modified based on at least one well-to-tank emissions value of a fuel input. For example, a well-to-tank emissions value may be added to a predicted emissions value to determine a predicted “well-to-wheel” emissions value. Thus, a “well-to-wheel” may refer to a cumulative value of emissions related to fuel production, processing, distribution, and use.

In some embodiments, when the vehicle is in a plug-in hybrid vehicle, the well-to-tank, or more specifically, a well-to-tank emissions values may be referred to as “well-to-battery” emissions values. For example, the well-to-battery emissions values may include an engine generated electricity emissions value, a renewable generated grid electricity emissions value, or a non-renewable grid generated electricity emissions value. The well-to-battery emissions values may include the total emissions to generate the electricity (e.g., power, voltage, amps, etc.) received by the battery 250. For example, the well-to-battery emissions values may include an amount of emissions to extract, refine, use, and/or transport a fuel (e.g., coal, oil, natural gas, etc.) for generating grid electricity. In an example embodiment, a total vehicular emissions, in the case of a plug-in hybrid vehicle, is equivalent to the emission produced by the ICE (e.g., a “tank-to-wheel” emissions value) plus the well-to-tank emissions of the fuel of the ICE plus the well-to-battery emissions values used to charge the battery. In an example operating scenario, a plug-in hybrid vehicle may be plugged-in to charge overnight and the well-to-battery emissions values may correspond to a value of emissions generated by the electricity received by the battery 250. In some embodiments, the well-to-battery emissions values may be received from a third-party computing system. In some embodiments, the well-to-battery emissions values may include an emissions amount of an exhaust gas species or multiple species per unit of energy (e.g., kilowatt, etc.). In some embodiments, the received well-to-battery emissions values correspond to a charge event (e.g., a time when the battery 250 is charging).

In some embodiments, for a plug-in hybrid vehicle, the well-to-battery emissions values are substantially similar to or the same as a well-to-wheel emissions value. In other embodiments, a well-to-wheel emissions value for a plug-in hybrid vehicle may be determined by adding a well-to-battery emissions value to a “battery-to-wheel” emissions value. As used herein the “battery-to-wheel” emissions value refers to an amount of emissions produced by providing battery charge to an electric motor that drives a wheel. The battery-to-wheel emissions value may be predicted and/or estimated based on a model (e.g., a statistical model, a regression model, a machine learning model, etc.) and/or one or more lookup tables. In either case, the model and/or the one or more lookup tables may correlate an amount of work performed by the wheels of the plug-in hybrid vehicle and/or an amount of energy provided by the battery to an emissions value. More specifically, the model and/or the one or more lookup tables may correlate a difference between the amount of work performed by the wheels of the plug-in hybrid vehicle and the amount of energy provided by the battery to an emissions value. Although the embodiments described herein are related to a “well to battery” emissions value, it should be understood that any of the embodiments described herein may use a “well to wheel” emissions value.

In some embodiments, the predicted values also include a predicted operational cost based on a time period, a route, a location, a destination, a vehicle operator, vehicle history, and/or any other metric. The predicted values may also include a predicted and/or simulated fleet outcome. The predicted fleet outcome may be compared against a fleet target (e.g., a fleet goal). For example, the fleet target may be a 30% GHG reduction goal, and the predicted fleet outcome may be compared against the fleet target. The simulated fleet outcome may include a predicted output for a defined period (e.g., an operating time, hours, or miles), a given route, a defined territory (e.g., geographical area, state, etc.), etc. In some embodiments, the simulated fleet outcome may also include a predicted output in consideration of differing WTT inputs including grid electricity versus electricity generated by an ICE, electricity from renewable versus electricity from non-renewable sources, and/or electricity from fossil fuel (e.g., diesel, natural gas, hydrogen, etc.). The simulated fleet outcome may also include predicted operational costs based on a time period, distance, a route, and/or a territory. At process 504, an operational data packet (which may include an emissions data packet) is received from one or more vehicles 202, 204, 206. The operational data packet is described above.

At process 506, the predicted emissions are compared to the actual emissions of the one or more vehicles 202, 204, 206 based on information from the operational data packet(s). The remote computing system 110 is structured to compare the predicted values generated at process 502 with the actual, detected values received in the operational data packet at process 504. When the predicted values are similar to the actual values, the process repeats to process 502 and continues verifying that the predicted values accurately predict the actual values. In some embodiments, the predicted values are considered similar if the predicted value is within a predetermined value of the actual value (e.g., within 5%, within 1%, within 0.1%, etc.). When the predicted values are non-equal to or non-similar to the actual values, the process proceeds to process 508.

At process 508, the predicted emissions output value(s) is/are re-calibrated. The remote computing system 110 is structured to adjust one or more inputs, constants, or other values to improve the accuracy of the predicted values (e.g., improve the models, improve the algorithms, equations, etc.). Re-calibrating the predicted emissions output value(s) may include re-calculating one or more statistical models using real sensor data of a particular vehicle and/or similar vehicles. For example, the remote computing system 110 may re-calculate a regression model to generate one or more new regression questions, retrain a machine learning model to output more accurate values, and/or provide new data to existing statistical models such that the statistical models output an updated, and, advantageously, more accurate values. Recalibrating predicted values may be used by the remote computing system 110 to better estimate emissions outputs for individual vehicles and/or a fleet of vehicles to help with monitoring and reporting requirements (e.g., as required by various agencies).

FIG. 6 is a flow diagram of a method 600 of reporting emissions for the vehicle 202 or a group of vehicles (e.g., a fleet), according to an example embodiment. In some embodiments, one or more of the computing systems of the system 100 is configured to perform method 600. For example, the remote computing system 110, the third party computing system 190, and/or the controller 300, may be structured to perform the method 600. In the example embodiment depicted, the remote computing system 110 performs the method 600, alone or in combination with other devices such as the controller 300 and the third party computing systems 190. In additional and/or alternative embodiments, the method 500 or parts thereof may be performed by the controller 300. The method 600 may include user inputs from a user (e.g., a provider employee, a third-party employee, a customer, a vehicle operator, etc.) one or more user devices (such as devices of provider employees, customer, a user device integrated with a vehicle, etc.), another computing device on the network 105, etc.

As an overview of method 600, at process 602, a predicted emissions output for one or more vehicles 202, 204, 206 is generated. At process 604, an operational data packet is received from one or more vehicles 202, 204, 206. At process 606, the predicted emissions and/or the actual emissions are compared to a threshold. At process 608, instructions to change one or more operational parameters are provided to the vehicle controller 300. In some embodiments, after process 608, the method 600 may continue with process 702, shown in FIG. 7. In some arrangements, the processes of the method 600 may be performed in a different order than as shown in FIG. 6. For example, processes 602 and 604 may be performed in any order, sequentially, concurrently, and/or partially concurrently. In some arrangements, the method 600 may include more or fewer processes than as shown in FIG. 6.

Referring to the method 600 in more detail, at process 602, predicted emissions output for one or more vehicles 202, 204, 206 is generated. Process 602 is substantially similar to or the same as process 502 of FIG. 5. At process 604, an operational data packet (which may include an emissions data packet) is received from one or more vehicles 202, 204, 206. Process 604 is substantially similar to or the same as process 504 of FIG. 5.

At process 606, the predicted emissions and/or the actual emissions are compared to a threshold. The threshold may include at least one of a GHG threshold, a PM threshold, or a NOx value threshold. In some embodiments, the remote computing system 110 is also structured to compare a predicted or actual value for a fuel efficiency, an operating cost, and/or any other operational data of the vehicle against a threshold associated for that value. A user (e.g., a customer, a user of a third party computing system 190, an operator or owner of a vehicle 202) may set/define the threshold (e.g., a maximum value, a minimum value, an acceptable range, etc.) and provide the threshold to the remote computing system 110. The predetermined threshold may be a dynamic threshold that changes in real time based on user inputs and/or vehicle operational data. The user may also indicate whether predicted emissions, actual emissions, or some combination thereof should be used when comparing vehicle operational data to the predetermined threshold. The remote computing system 110 may compare predicted emissions, actual emissions, or a combination thereof with the predetermined threshold based on the user indication. The predetermined threshold may include a service provider preference, a customer preference, a law or regulation, and/or other preferable or mandatory parameters related to the threshold. The threshold is at least one of a regulatory threshold (e.g., set by a rule, law, regulation, or other mandatory limit), a preferred threshold (e.g., a non-mandatory limit), or a combination thereof (e.g., different thresholds for different metrics, such as fuel economy or emissions).

In some embodiments, at least one well-to-tank emission value and/or at least one well-to-wheel emissions value is/are compared to a corresponding threshold. For example, the remote computing system 110 may determine that at least one well-to-tank emission value and/or at least one well-to-wheel emissions value is above the predetermined threshold and continue to process 608. In another example, the remote computing system 110 may determine that the well-to-tank emissions value and/or the well-to-wheel emissions value is/are below the predetermined threshold and continue to process 602.

In some embodiments, a vehicle owner (e.g., a vehicle operator) and/or a fleet owner or operator may acquire emission credits (e.g., carbon credits). Vehicle and/or fleet owner may earn emission credits for reducing emissions of NOx, PM, GHG, and/or other emissions beyond what is required by regulations. For example, a vehicle and/or a fleet of vehicles that has emissions outputs that are below a regulation threshold may earn emissions credits for the vehicle and/or fleet owner. Vehicle owners and/or fleet owners may also purchase emissions credits. After acquiring the emission credits, the vehicle owner may use the emissions credits to offset regulatory threshold values which may be used to determine compliance and/or non-compliance with various thresholds.

In some embodiments, the threshold is modified by one or more threshold modifiers. In some embodiments, the threshold modifier may include a multiplier that multiplies with the threshold value. In some embodiments, the threshold modifier is an additive modifier that is added to or subtracted from the threshold value. In some embodiments, the threshold modifier is a time period such that only emission values recorded within a specific time period (or outside of a specific time period) are compared to the threshold. In any of the embodiments described herein, the threshold modifier is applied to the threshold such that the threshold value is changed before being compared to the emissions values. In an example embodiment, when a threshold is limited by a regulation, the threshold is modified by one or more of a multiplier, an additive modifier (e.g., a number of emission credits used to offset or increase the threshold and/or a goal amount of emissions credits to earn to decrease the threshold), and/or by a predetermined time period. More specifically, when using an emissions credit to offset vehicle emissions, an emissions credit may correspond to a first predetermined amount to increase the threshold. Accordingly, using one or more emissions credits to increase the threshold includes adding the predetermined amount to the threshold for each emissions credit used. That is, using more emissions credits increases the threshold. Similarly, when earning an emissions credit, an emissions credit may correspond to a second predetermined amount to decrease the threshold. Accordingly, to earn a goal amount of emissions credits, the second predetermined amount is subtracted from the threshold for each emissions credit of the goal amount of emissions credits. If the emissions do not exceed the threshold, the method 600 returns to process 602. If the emissions exceed the threshold, the method 600 continues to process 608. In this case, the threshold corresponds with a maximum allowed limit. In other cases and as described above, the threshold may be a minimum value, a range, etc.

At process 608, instructions to change operational parameters are provided to the vehicle controller 300. The remote computing system 110 is structured to cause, based on the comparison to the threshold, the vehicle controller 300 to change an operational parameter regarding, for example, the cylinder 212, the engine 210, the vehicle 202, and/or the fleet 200. For example, the operational parameter may include, but is not limited to a fuel-to-air mixture, a fluid flow rate through a filter (which may be adjusted via a changing of one or more valve positions, such as an intake air valve), a cruise control droop amount, a transmission shift schedule, a maximum engine speed, a maximum engine torque, a maximum engine power, derate trigger conditions, etc. As briefly described above, the method 600 may continue to the method 700 after process 410.

FIG. 7 is a flow diagram of a method 700 of reporting emissions for the vehicle 202 of FIG. 2, according to an example embodiment. In some embodiments, one or more of the computing systems of the system 100 is configured to perform method 700. For example, the remote computing system 110, the third party computing system 190, and/or the controller 300, may be structured to perform the method 700. In the example embodiment depicted, the remote computing system 110 and the controller 300 performs the method 700, alone or in combination with other devices such as the third party computing systems 190. The method 700 may include user inputs from a user (e.g., a provider employee, a third-party employee, a customer, a vehicle operator, etc.) one or more user devices (such as devices of provider employees, customer, a user device integrated with a vehicle, etc.), another computing device on the network 105, etc.

As overview of method 700, at process 702, a vehicle data request is received. At process 704, a reporting method is determined. At process 706, a vehicle reporting data packet is generated. At process 708, the vehicle reporting data packet is provided to one or more third party computing systems 190. At process 710, operational data packets are received from the vehicle 202. At process 712, a remote computing reporting data packet is generated. At process 714, the remote computing reporting data packet is provided to one or more third party computing system 190. In some arrangements, the processes of the method 700 may be performed in a different order than as shown in FIG. 6. For example, processes 706 and 710 may be performed in any order, sequentially, concurrently, and/or partially concurrently. In some arrangements, the method 600 may include more or fewer processes than as shown in FIG. 7. For example, processes 706 and 708 may be mutually exclusive with processes 710, 712, and 714.

Referring to the method 700 in more detail, at process 702, a vehicle data request is received. As described above, the vehicle data request refers to information about one or more vehicles 202, 204, 206 and/or a fleet 200 (e.g., vehicle operational data such as sensed and detected values (e.g., sensor data from an actual sensor), predicted or determined values (e.g., predicted or determined values from a virtual sensor, computing system, and/or statistical model), metadata including timestamps, geo-location stamps, and/or identifiers (e.g., vehicle identifiers, engine identifiers, etc.), and/or any other information described herein). In some embodiments, the request includes a vehicle identifier (e.g., a serial number, a VIN, a controller IP address), such that the request can be sent to and/or received by a specific vehicle or group of vehicles. The remote computing system 110 may also be structured to receive the vehicle data request. The request is received by the vehicles 202, 204, 206 and/or the remote computing system 110 from one or more of the third party computing systems 190. For example, the request may be provided from one or more of a third party computing system 190 associated with a customer, a regulatory body, a government agency, and/or any other third party computing system 190 that is associated with a third-party that is interested in one or more of the vehicles 202, 204, 206.

In some embodiments, the vehicle data request requests data for one or more vehicles (e.g., one or more of the vehicles on the fleet 200), a component of the vehicles (e.g., the engine 210, the cylinder 212), or any combination thereof. The request includes a request for operational data such as a NOx output, a GHG output, and/or a PM output (a cumulative amount, an instantaneous amount, a combination thereof at one or more locations). In some embodiments, the request alternatively and/or additionally includes a request for predicted values generated by the remote computing system 110. In some embodiments, and as described above, the request may be part of a subscription-based service.

In some embodiments, the request is a one-time request for vehicle information. In other embodiments, the request is a recurring request for vehicle information (e.g., every hour, every day, every month, every 100 miles, every time a vehicle enters and/or exists a given location or region, etc.). In some embodiments, the request is a regulatory test and includes predetermined operational data.

In some embodiments, the request includes a request for vehicle reporting data and/or remote computing reporting data. As used herein “remote computing reporting data” and similar terms are used to mean a reporting data packet generated and/or transmitted by the remote computing system 110. For example, the remote computing system 110 may generate and/or transmit a remote computing reporting data packet as described herein below, with respect to processes 712 and 714. However, it should be understood that, in some embodiments, the controller 300 may, at least partially, generate the remote computing reporting data packet described below. Relative to the operational data packet, the remote computing reporting data packet may include additional information, such as information regarding compliance with one or more standards or thresholds (e.g., emissions compliance, engine noise compliance, etc.), historical or trend information regarding the vehicle, and so on. The remote computing reporting data packet may be specific to an individual vehicle or include information regarding a fleet of vehicles or equipment (e.g., powertrain units, gensets, etc.). While various aspects are primarily described below with respect to an individual vehicle, it should be appreciated that the remote computing system 110 may generate information for the fleet or a subset of the fleet (e.g., fuel economy averages for multiple vehicles, emissions information for multiple vehicles, etc.). In this regard, the remote computing reporting data packet may also include determinations made by the remote computing system 110. Thus, the remote computing reporting data packet may be broader dataset compared to the operational data packet. In some embodiments, the remote computing reporting data packet includes additional sensor data that is detected after changing the operational parameters at process 410. The remote computing reporting data packet includes the same or similar information as the operational data packet as described above with respect to FIGS. 4-6 as well as additional information described herein. For example, the remote computing reporting data packet may also include updated information, such as an indication that the changed parameter did not change certain detected values. The remote computing reporting data packet may also include historical and/or trend data. For example, the remote computing reporting data packet may include an indication that a particular component and/or system is degrading over time. The remote computing reporting data packet also includes an indication of lube-oil status (e.g., a time since last changed), operation time or an age of a catalyst, filter, or other exhaust treatment element, a time since last service of the exhaust treatment element, and/or other operational data. The remote computing data packet may also include at least one of a predicted emissions output (e.g., predicted engine out NOx, predicted system out NOx (e.g., at the tailpipe), predicted particulate matter output at various locations, etc.), an actual emissions output (e.g., a sensed NOx output amount at the engine, system, or another location; a sensed PM output amount at the engine, at the system, and/or another location; a sensed GHG amount at various locations; etc.), an operational parameter that was changed, a result of the changed operational parameter (e.g., an updated actual emissions output), and/or any other operational data associated with the cylinder 212, the engine 210, the vehicle 202, and/or the fleet 200.

In some embodiments, the remote computing reporting data packet may include a cumulative emissions output compared to a regulatory limit. In these embodiments, multiple operational data packets may be utilized to determine data over a period of time and/or to determine data for one or more vehicles or equipment (e.g., a fleet subgroup, a territory subgroup, an engine type subgroup, an engine displacement subgroup, etc.).

As briefly described above, the remote computing report data packet may alternatively and/or additionally include indications of compliance and/or non-compliance (e.g., for individual vehicles, a fleet of vehicles, and/or a subset of vehicles of the fleet). Compliance or non-compliance may be in regard to one or more values of the operational data that exceed or are below a predefined threshold(s). In these embodiments, the remote computing report data may also include an indication of subsequent actions (e.g., changes in operational parameters) to demonstrate a return or an attempt of a return to compliance. In some embodiments, the remote computing report data also includes an indication of subsequent actions (e.g., faults, engine disablements, a requirement for service, etc.). Accordingly in some embodiments, the remote computing report data packets includes a compliance data packet that includes compliance related information, such as an indication that a vehicle is compliant, an indication that a vehicle is non-complaint, and indication of a corrective action taken to return to compliance, vehicle operational data, including sensor data (e.g., data from a real sensor and/or from a virtual sensor), showing a change in vehicle operational data from before the corrective action to after the corrective action, where the change is shown by the sensor data and/or a change in the vehicle operational data. In other embodiments, the compliance data packet is a separate data packet. The compliance data packet may be generated by the vehicle 202 and/or the remote computing system 110.

Thus, the remote computing report data packet may provide an indication of vehicle operational data including one or more vehicle operational parameters, an indication of whether the operational data value(s) is/are non-complaint and/or exceeds/is below one or more predefined thresholds, an indication of a corrective action taken to return to compliance and/or not exceed/be below one or more predefined threshold values, and so on.

In some embodiments, the remote computing report data packet may include a cumulative emissions output compared to a limit, such as a regulatory value (e.g., minimum amount, limit, etc.). For example, the cumulative emissions may include NOx, PM, etc. versus one or more regulation limits. In these embodiments, multiple operational data packets may be utilized from multiple vehicles or equipment (e.g., a fleet subgroup, a territory subgroup, an engine type subgroup, etc.). The multiple operational data packets may be grouped together based on a variety of conditions, such as engine identifiers, powertrain identifiers, a fuel type and/or a fuel source (fuel properties, fuel source location, renewable versus non-renewable, WTT analysis, etc.), and so on.

In some embodiments, the remote computing report data packet may also include a fuel economy data packet for monitoring, reporting, and/or optimizing a fuel economy of a vehicle, a set of vehicles of the fleet, the fleet itself, or a combination thereof. The fuel economy data packet may include a historical fuel economy value for a defined period of time or distance (e.g., an operating time, hours, or miles), a given route, and/or within a predetermined geographic area (e.g., a state, a territory, etc.).

As used herein “vehicle reporting data” and similar terms are used to mean a reporting data packet generated and/or transmitted by a vehicle 202 and/or a component there of (e.g., the controller 300). For example, the controller 300 may generate and/or transmit a remote computing reporting data packet as described herein below, with respect to processes 706 and 708. However, it should be understood that, in some embodiments, the remote computing system 110 may, at least partially, generate the remote computing reporting data packet described below. In some embodiments, the vehicle reporting data packet may be the same or similar to the remote computing reporting data packet, described herein above, except that the vehicle reporting data packet is generated and/or transmitted by the controller 300 and includes data (e.g., operational parameters, operational data, and/or other data described herein) associated with a particular vehicle associated with the controller 300, such as the vehicle 202. In this regard, the vehicle reporting data packet may include a fuel economy data packet, a compliance data packet, and so on as described herein with respect to the remote computing data packet. But, the information is specific to that vehicle as compared to a fleet of vehicles, potentially, with the remote computing reporting data packet. Accordingly, the vehicle reporting data packet includes at least one of a predicted emissions output (e.g., predicted engine out NOx, predicted system out NOx (e.g., at the tailpipe), predicted particulate matter output at various locations, etc.), an actual emissions output (e.g., a sensed NOx output amount at the engine, system, or another location; a sensed PM output amount at the engine, at the system, and/or another location; a sensed GHG amount at various locations; etc.), an operational parameter that was changed, a result of the changed operational parameter (e.g., an updated actual emissions output), and/or any other operational data associated with the cylinder 212, the engine 210, the vehicle 202, and/or the fleet 200.

In some embodiments, the vehicle reporting data packet may include a cumulative emissions output compared to a regulatory limit. In these embodiments, multiple operational data packets may be utilized to determine data over a period of time.

At process 704, a reporting method is determined. The request includes an indication of whether the vehicle data (e.g., the operational data and/or the operational parameters) should be reported directly from a vehicle (e.g., vehicle 202), or from the remote computing system 110. Accordingly, the controller 300 and/or the remote computing system 110 is/are structured to determine whether to report the data to the third party computing systems 190. If the vehicle data is to be reported directly from a vehicle, the method 700 continues to process 706. If the vehicle data is to be reported directly from the remote computing system 110, the method 700 continues to process 710. If the vehicle data is to be reported directly from both the vehicle and the remote computing system 110, the method 700 may continue to processes 706 and 710 sequentially (in any order), concurrently, or partially concurrently.

In some embodiments, the controller 300 and/or the remote computing system 110 is/are structured to determine whether to report the data to the third party computing systems 190 without receiving a request first. Accordingly, the controller 300 and/or the remote computing system 110 is/are structured to select a reporting method without a specific request and proceed with the method 700 without receiving a request at process 702.

At process 706, a vehicle reporting data packet is generated. As described above, the vehicle reporting data packet includes vehicle information, such as operational data and/or operational parameters associated with the vehicle 202. In some embodiments, the controller 300 is structured to customize the vehicle reporting data packet to include only operational data and/or operational parameters that were part of the request. This saves network bandwidth, facilitates quick processing of requests, and overall improves computer operability.

At process 708, the vehicle reporting data packet is provided to one or more third party computing systems 190. The controller 300 is structured to provide the vehicle reporting data packet to the third party computing systems 190 associated with the request. In some embodiments, the controller 300 is structured to provide the vehicle reporting data packet to other third party computing systems 190 that were not associated with the request, but are associated with the vehicle. For example, the controller 300 is structured to provide the vehicle reporting data packet to a computing system of a customer when a regulatory body submits a request. In some embodiments, the controller 300 is also structured to provide the vehicle reporting data packet to the remote computing system 110. In some embodiments, the controller 300 is structured to automatically provide additional vehicle reporting data packets to the third party computing systems 190 based on the request being a recurring request. In some embodiments, the vehicle reporting data packet is also provided to one or more vehicles in the fleet 200. In some embodiments, the vehicle reporting data packet is broadcast to the remote computing system 110, the third party computing systems 190, and/or one or more vehicles in the fleet 200. As used herein the term “broadcast” and similar terms are used to mean transmitting data (e.g., vehicle reporting data packets and/or other data packets) from a first computing system (e.g., the remote computing system 110, the controller 300, etc.) to one or more other computing systems (e.g., the remote computing system 110, the controller 300, the third party computing system 190, etc.). The vehicle reporting data packet may be broadcast to other computing systems responsive to a request (e.g., the request received at process 702) and/or automatically (e.g., without a request).

At process 710, operational data packets (which may include an emissions data packet) are received from the vehicle 202. As described above with respect to FIGS. 5 and 6, the remote computing system 110 is structured to receive operational data packets from the vehicle 202. At process 712, a remote computing reporting data packet is generated. As described above, the remote computing reporting data packet includes vehicle information, such as operational data and/or operational parameters associated with one or more vehicles (202, 204, 206) and/or the fleet 200. In some embodiments, the remote computing system 110 is structured to customize the remote computing reporting data packet to include only operational data and/or operational parameters that were part of the request.

At process 714, the remote computing reporting data packet is provided to one or more third party computing system 190. The remote computing system 110 is structured to provide the remote computing reporting data packet to the third party computing systems 190 associated with the request. In some embodiments, the remote computing system 110 is structured to provide the remote computing reporting data packet to other third party computing systems 190 that were not associated with the request, but are associated with the vehicle. For example, the remote computing system 110 is structured to provide the remote computing reporting data packet to a computing system of a customer when a regulatory body submits a request. In some embodiments, the remote computing system 110 is also structured to provide the remote computing reporting data packet to the controller 300. In some embodiments, the remote computing system 110 is structured to automatically provide additional remote computing reporting data packets to the third party computing systems 190 based on the request being a recurring request. In some embodiments, the remote computing system 110 is structured to broadcast the remote computing reporting data packet to other computing systems responsive to a request (e.g., the request received at process 702) and/or automatically (e.g., without a request).

In one example, a graphical user interface (GUI) is generated and provided that depicts the one or more remote computing reporting data packets. The GUI may be provided on display device, such as a touchscreen of a vehicle in the fleet and/or computing device (e.g., a tablet computer), and include one or more selectable elements (e.g., icons with embedded hyperlinks, etc.) that enable a drill-down onto various elements, such as fuel economy for individual vehicles, for the fleet; emissions information for individual vehicles, for the fleet; etc.

In some embodiments, one or more of the method 400, the method 500, the method 600, and the method 700 may be performed as a combined method. Accordingly, the combined method may include performing one or more of the method 400, the method 500, the method 600, and the method 700 sequentially (in any order), concurrently, or partially concurrently. As described above, each of the method 400, the method 500, the method 600, and the method 700 may include more or fewer steps than as shown in FIGS. 4-7. Accordingly, the combined method may also include more or fewer steps than as shown in FIGS. 4-7 and described herein.

The combined method may be a method of high level vehicle and/or fleet monitoring and data reporting. Accordingly, operational data and/or operational parameters of the fleet 200 and/or a specific vehicle 202 or group of vehicles 202, 204, 206 may be monitored by the remote computing system 110, and the operational data and/or operational parameters may be reported (e.g., broadcast) to one or more third party computing system 190.

In an example embodiment, the combined method may include a real-time computation and broadcast (e.g., reporting) of exhaust emissions levels (e.g., emissions values, such as cumulative emissions, emissions over time, and/or other emissions values described herein). For example, a reporting data packet (e.g., the vehicle reporting data packet and/or the remote computing data packet) may be broadcast (e.g., by the remote computing system 110 and/or the vehicle 202) to one or more computing systems (e.g., the third party computing system 190). The reporting data packet may include an indication of cumulative emissions compared to a threshold value (e.g., a regulatory limit, etc.), an indication of non-compliance data (e.g., a compliance data packet) including subsequent actions and/or data demonstrating a return to compliance, and/or non-compliance data (e.g., a compliance data packet) including subsequent actions (e.g., faults, engine disablements) to communicate that vehicle service and/or repair is required. In some embodiments, the reporting data packet may be broadcast for a specific vehicle, engine, or powertrain. Additionally and/or alternatively, the reporting data packet may be broadcast for a grouping or subgrouping of vehicles, engines, or powertrains. The groupings and/or subgroupings may be defined by a fleet, a territory, a vehicle or engine type, an engine displacement, etc. The reporting data packet may additionally and/or alternatively include a correlation of data with the fuel type and/or fuel source (e.g., fuel properties, fuel source location, an indication of whether the fuel is renewable or non-renewable, WTT, etc.).

In another example embodiment, the combined method may include adjustment of a vehicle, engine, or powertrain based on operational data. For example, the controller 300 (or one or more of the specialized processing circuits thereof) may adjust an operating parameter of the vehicle 202 based on operational data received from the sensors of the vehicle 202. In some embodiments, the adjustment may be made based on sensed data (e.g., from an actual sensor), predicted/estimated values (e.g., from a virtual sensor), calculations made by the controller 300 and/or the remote computing system 110, and/or historic values (e.g., operational parameter settings resulting in similar desired outputs). In an example embodiment, the method includes a real-time adjustment of a vehicle, engine, or powertrain based on real-time emissions data. The emissions data may include predicted and/or sensed emissions values. Accordingly, combined method may include adjusting one or more parameters of a vehicle based on the sensed or predicted emissions data as described herein above with respect to the process 410.

In yet another example embodiment, the combined method may include a real-time reporting subscription service. For example, the reporting data packets may be available through a subscription-based service that is provided by the remote computing system 110 and/or the vehicle 202. The subscription-based service may be a fee-based service that allows users of the third party computing systems 190 to view a graphical user interface depicting data from the reporting data packets. The GUI may be provided upon payment of a fee (e.g., periodic, one-time, a combination thereof, etc.). The reporting data packets may be used to monitor, manage, report, and optimize operations (cost, emissions, routes, etc.). In some embodiments, the subscription-based service includes automatically providing the reports to additional third parties. For example, a first third party (e.g., a customer) purchases the subscription-based service and the remote computing system 110 can provide the reports to a second third party (e.g., a government agency, a regulatory body, etc.) on behalf of the first third party. Accordingly and as described herein, the report may include vehicle information (e.g., operational data and/or operational parameters) including, for example, engine performance data, emissions data, and/or indications of compliance, non-compliance and/or corrective actions based on non-compliance, and/or other information regarding tacked vehicle and/or fleet data.

In an example operating scenario, the remote computing system 110 is configured to control the operation of a hybrid powertrain vehicle. The remote computing system 110 may receive, from a sensor of the hybrid powertrain vehicle, a first emissions value. The sensor may be an air sensor 240 (e.g., a NOx sensor 242, a particulate sensor 244, and a GHG sensor 246, etc.). In turn, the first emissions value may be a NOx value, a particulate value, a GHG value, etc. The remote computing system 110 may compare the first emissions value to a predefined threshold value. For example, the predefined threshold may be a maximum emissions value (e.g., a maximum NOx value, a maximum particulate value, a maximum GHG value). As described herein, the maximum emissions value may be determined based on a regulation (e.g., a threshold set by a regulatory body or government agency) and/or an emissions goal. The remote computing system 110 may determine that the first emissions value exceeds the predefined threshold value. The remote computing system 110 may cause a heater of the hybrid powertrain vehicle to turn on or increase in power such that an exhaust gas produced by the engine 210 of the vehicle is heated by the heater.

After causing the heater to turn on or increase in power, the remote computing system 110 may receive a second emissions value form the sensor. The remote computing system 110 may compare the second emissions value to the predefined threshold. The remote computing system 110 may determine that the second emissions value exceeds the predefined threshold value. The remote computing system 110 may cause the hybrid powertrain to change from an engine only operating mode to an electric motor only operating mode and/or an electric motor and engine combination operating mode.

In some embodiments, a method of controlling and/or monitoring a plug-in hybrid vehicle that includes a hybrid powertrain, includes receiving, by a computing system, a first set of well-to-battery emissions values. The method also includes receiving, by the computing system, a first set of well-to-tank emissions values. The method further includes determining, by the computing system, a total vehicle emissions value based on an aggregate of the emissions first set of well-to-battery emissions values, the first set of well-to-tank emissions values, and a first set of emissions values produced by an engine of the hybrid powertrain. The method also includes determining, by the computing system, that the total vehicle emissions value exceeds a predefined threshold value, and causing, by the computing system, the hybrid powertrain to change a first operational parameter responsive to determining that the first emissions value exceeds the predefined threshold value. In some embodiments, the first set of well-to-tank emissions values correspond to a fuel received by a fuel system of the vehicle. In some embodiments, the well-to-battery emissions values correspond to a charge event of the plug-in hybrid vehicle. In some embodiments, the method includes generating, by the computing system, a set of predicted emissions values, wherein the set of predicted emissions values are the first set of emissions values produced by an engine. In some embodiments, the method includes receiving, by the computing system and from a sensor, the set of predicted emissions values are the first set of emissions values produced by an engine.

In some embodiments, the method also includes receiving, by the computing system and from a sensor, a second emissions value; determining, by the computing system, that the second emissions value exceeds the predefined threshold value; and causing, by the computing system, the hybrid powertrain to switch from a first mode of operation to a second mode of operation responsive to determining that the second emissions value exceeds the predefined threshold value. In some embodiments, the method also includes causing, by the computing system, the mild-hybrid powertrain to switch to from the second mode of operation to the first mode of operation responsive to identifying an emergency scenario.

By accounting for a total emissions value (e.g., the well-to-tank and tank-to-wheel aggregate total), the systems and methods described herein may mitigate against undesirable emissions from the vehicle and that indirectly affect the vehicle.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using one or more separate intervening members, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

While various circuits with particular functionality are shown in FIGS. 1 and 3, it should be understood that the remote computing system 110 and/or the controller 300 may include any number of circuits for completing the functions described herein. For example, the activities and functionalities of the sensor control circuit 320, the engine/cylinder control circuit 322, the battery control circuit 324, the fuel control circuit 326, and the air system control circuit 238 may be combined in multiple circuits or as a single circuit. Additional circuits with additional functionality may also be included. Further, the controller 300 may further control other activity beyond the scope of the present disclosure.

As mentioned above and in one configuration, the “circuits” may be implemented in machine-readable medium for execution by various types of processors, such as the processor 314 of FIG. 3. Executable code may, for instance, comprise one or more physical or logical blocks of computer instructions, which may, for instance, be organized as an object, procedure, or function. Nevertheless, the executables need not be physically located together, but may comprise disparate instructions stored in different locations which, when joined logically together, comprise the circuit and achieve the stated purpose for the circuit. Indeed, a circuit of computer readable program code may be a single instruction, or many instructions, and may even be distributed over several different code segments, among different programs, and across several memory devices. Similarly, operational data may be identified and illustrated herein within circuits, and may be embodied in any suitable form and organized within any suitable type of data structure. The operational data may be collected as a single data set, or may be distributed over different locations including over different storage devices, and may exist, at least partially, merely as electronic signals on a system or network.

While the term “processor” is briefly defined above, the term “processor” and “processing circuit” are meant to be broadly interpreted. In this regard and as mentioned above, the “processor” may be implemented as one or more processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

Embodiments within the scope of the present disclosure include program products comprising computer or machine-readable media for carrying or having computer or machine-executable instructions or data structures stored thereon. Such machine-readable media can be any available media that can be accessed by a computer. The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing. More specific examples of the computer readable medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device. Machine-executable instructions include, for example, instructions and data which cause a computer or processing machine to perform a certain function or group of functions.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireless, wireline, optical fiber cable, Radio Frequency (RF), or the like, or any suitable combination of the foregoing

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present disclosure may be written in any combination of one or more other programming languages, including an object oriented programming language such as Java, Smalltalk, C++ or the like and conventional procedural programming languages, such as the “C” programming language or similar programming languages. The computer readable program code may execute entirely on the user's computer, partly on the user's computer, as a stand-alone computer-readable package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

Although the figures and description may illustrate a specific order of method processes, the order of such processes may differ from what is depicted and described, unless specified differently above. Also, two or more processes may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection processes, processing processes, comparison processes, and decision processes.

It is important to note that the construction and arrangement of the apparatus and system as shown in the various exemplary embodiments is illustrative only. Additionally, any element disclosed in one embodiment may be incorporated or utilized with any other embodiment disclosed herein.

What is claimed is:

1. A method comprising:
receiving, by a remote computing system, a first emissions data packet from a vehicle controller, the first emissions data packet comprising a plurality of emissions values regarding operation of a vehicle associated with the vehicle controller;
determining, by the remote computing system, that a first cumulative emissions value is greater than a threshold value, the first cumulative emissions value based on the plurality of emissions values; and
responsive to determining that the first cumulative emissions value is greater than the threshold value, performing, by the remote computing system, corrective operations comprising:
transmitting an indication that the first cumulative emissions value is greater than the threshold value to a third-party computing system, the indication including a request to perform a service operation on the vehicle;
causing the vehicle to change an operational parameter;
receiving a second emissions data packet from the vehicle; and
responsive to determining that a second cumulative emissions value is less than the threshold value, transmitting, by the remote computing system, a compliance data packet to the third-party computing system, the compliance data packet comprising the second emissions data packet and the changed operational parameter.

2. The method of claim 1, further comprising:
receiving, by the remote computing system, a plurality of emissions data packets, each of the plurality of emissions data packets associated with a respective vehicle of a plurality of vehicles; and
transmitting, by the remote computing system, the plurality of emissions data packets to the third-party computing system.

3. The method of claim 2, wherein each of the plurality of vehicles is grouped by at least one of a fleet, a territory, or a vehicle type.

4. The method of claim 1, wherein the first emissions data packet further comprises a fuel type and a fuel source.

5. The method of claim 1, wherein the third-party computing system includes at least one of a fleet computing system, an operator computing system, an original equipment manufacturer computing system, a distributor computing system, or a repair facility computing system.

6. The method of claim 1, wherein causing the vehicle to change the operational parameter comprises causing the vehicle to change at least one of:
a fuel-to-air mixture,
a fluid flow rate through a filter,
a cruise control droop amount,
a transmission shift schedule,
a maximum engine speed,
a maximum engine torque,
a maximum engine power, or
a derate trigger condition.

7. The method of claim 1, wherein the compliance data packet further comprises the first emissions data packet and a change in the plurality of emissions values between the first emissions data packet and the second emissions data packet.

8. A method comprising:
generating, by a remote computing system, a first predicted set of emissions values regarding operation of a vehicle;
receiving, by the remote computing system, a first actual set of emissions values regarding operation of the vehicle from a vehicle computing system; and
responsive to determining that at least one of the first predicted set of emissions values or the first actual set of emissions values is above a predetermined threshold, transmitting, by the remote computing system, an instruction to change an operational parameter to the vehicle computing system, wherein changing the operational parameter includes at least one of:
adjusting a fuel injection quantity, a fuel injection timing, or a fuel injection event;
adjusting an air handling system;
adjusting a fuel-to-air ratio;
implementing a cylinder deactivation mode; or
activating a heater disposed in an exhaust aftertreatment system.

9. The method of claim 8, wherein the vehicle is a hybrid vehicle; and
wherein changing the operational parameter further includes adjusting an engine to electric battery load based on at least one of an engine status, an engine health, the first predicted set of emissions values, or the first actual set of emissions values.

10. The method of claim 9, the method further comprising responsive to adjusting the engine to electric battery load:
generating, by the remote computing system, a second predicted set of emissions values regarding operation of the vehicle;
receiving, by the remote computing system, a second actual set of emissions values regarding operation of the vehicle; and
causing the hybrid vehicle to change from a first operating mode to a second operating mode responsive to determining that at least one of the second predicted set of emissions values or the second actual set of emissions values is above the predetermined threshold.

11. The method of claim 10, wherein the method further comprises:
receiving, by the remote computing system, at least one well-to-tank emissions value of a fuel input, the at least one well-to-tank emissions value of the fuel input comprising at least one of an engine generated electricity emissions value, a renewable generated grid electricity emissions value, or a non-renewable grid generated electricity emissions value; and
modifying at least one emissions value of the second predicted set of emissions values regarding operation of the vehicle with the at least one well-to-tank emissions value to determine a well-to-wheel value;
wherein determining that at least one of the second predicted set of emissions values or the second actual set of emissions values is above the predetermined threshold comprises determining the well-to-wheel value is above the predetermined threshold.

12. The method of claim 8, wherein during implementation of the cylinder deactivation mode, the method further comprises:
identifying, by the remote computing system, a non-compliant cylinder of a plurality of engine cylinders; and
disabling, by the remote computing system, the non-compliant cylinder.

13. The method of claim 12, wherein identifying, by the remote computing system, the non-compliant cylinder includes:
temporarily disabling each cylinder of a plurality of cylinders in a predetermined pattern;
receiving, by the remote computing system, a disabled-cylinder emissions output for each cylinder of the plurality of cylinders in the predetermined pattern; and
identifying, by the remote computing system and based on the disabled-cylinder emissions output, at least one non-compliant cylinder.

14. The method of claim 13, wherein identifying the at least one non-compliant cylinder comprises determining that a value of the disabled-cylinder emissions output for the at least one non-compliant cylinder does not satisfy a corresponding threshold, wherein the value comprises at least one of:
a combustion temperature that is below a temperature threshold,
a pressure value that is below a pressure threshold,
a power output that is below a power threshold, or
an emissions value that is above an emissions threshold.

15. The method of claim 8, wherein the method further comprises:
generating, by the remote computing system, a reporting data packet, the reporting data packet comprising at least one of the first actual set of emissions values or the first predicted set of emissions values;
receiving, by the remote computing system, a first request for a data subscription service;
transmitting, by the remote computing system, the reporting data packet responsive to receiving the first request; and
automatically transmitting, by the remote computing system, the reporting data packet to a third-party computing system.

16. The method of claim 15, wherein the first request for the data subscription service is approved by the third-party computing system.

17. A method of controlling a mild-hybrid powertrain, the method comprising:
receiving, from a first sensor of the mild-hybrid powertrain, a first emissions value;
determining that the first emissions value exceeds a predefined threshold value;
causing the mild-hybrid powertrain to change a first operational parameter responsive to determining that the first emissions value exceeds the predefined threshold value;
receiving, from the first sensor, a second emissions value;
determining that the second emissions value exceeds the predefined threshold value;
causing the mild-hybrid powertrain to switch from a first mode of operation to a second mode of operation responsive to determining that the second emissions value exceeds the predefined threshold value; and
causing the mild-hybrid powertrain to switch to from the second mode of operation to the first mode of operation responsive to identifying an emergency scenario.

18. The method of claim 17, wherein causing the mild-hybrid powertrain to change the first operational parameter comprises activation of an electric heater within an aftertreatment system of the mild-hybrid powertrain, the electric heater configured to heat exhaust gas output by the mild-hybrid powertrain.

19. The method of claim 17, wherein the second mode of operation is an electric motor only mode of operation, and wherein the first mode of operation is an internal combustion engine only mode of operation.

20. The method of claim 17, wherein the first mode of operation is an internal combustion engine only mode of operation, and wherein the emergency scenario includes a battery state of charge being below a predefined battery threshold value.
